(19) United States
(12) Patent Application Publication
(10) Pub. No.: US 2023/0113735 A1
(43) Pub. Date: Apr. 13, 2023

(54) OPTICAL FIBER CONNECTOR

(71) Applicant: TDK Corporation, Tokyo (JP)

(72) Inventors: Ryogen FUJIWARA, Tokyo (JP); Nobuyuki SHIMBO, Tokyo (JP)

(21) Appl. No.: 17/802,446

(22) PCT Filed: Feb. 26, 2021
(86) PCT No.: PCT/JP2021/007484

§ 371 Date: Aug. 25, 2022

(30) Foreign Application Priority Data
Feb. 27, 2020 (JP) 2020-032006
Feb. 27, 2020 (JP) 2020-032007

(51) Int. Cl. G02B 6/38; G02B 6/40

(52) U.S. Cl. CPC G02B 6/3825; G02B 6/403

(57) ABSTRACT

An optical fiber connector includes an adaptor having an insertion hole and first and second plugs holding, respectively, first and second optical fibers. The adaptor has first and second attracting surfaces having, respectively, one and the other insertion ports of the insertion hole. The first plug has a first attracted surface that receives, from the first attracting surface, an attractive force generated by a magnetic force when the first optical fiber is inserted into the one insertion port. One of the first attracting surface and the first attracted surface is constituted by a permanent magnet, and the other one thereof is constituted by a magnetic body. In a connection state between the first and second optical fibers, at least the outer peripheral edge of the first attracted surface does not continuously contact the outer peripheral edge of the first attracting surface.

### TECHNICAL FIELD

The present invention relates to an optical fiber connector for connection of an optical fiber and, more particularly, to a structure thereof that connects an optical fiber utilizing a magnet.

### BACKGROUND ART

There are various types of optical fiber connectors for mutually connecting wiring cables such as optical fibers installed in a house or a building. Among them, an SC-type optical fiber connector (JIS C 5973 (F04) type) and an LC-type optical fiber connector (JIS C 5964-20 type) are most widely used. The SC-type and LC-type optical fiber connectors use PC (Physical contact) connection that physically mutually connects end surfaces of respective optical fibers, and a pressing force required for this connection is generated using a spring.

When a spring is used to generate a pressing force, the connector needs to be partly movable. This complicates the structure of the optical fiber connector to impede size and cost reduction. Further, complication in assembly work is an obstacle to reduction in construction time. To cope with this, there is proposed an optical fiber connector that can achieve size and cost reduction with a simple structure by using a magnetic force to generate a pressing force (see Patent Documents 1 and 2).

Further, there is proposed an optical fiber connector that mutually connects core wires of respective optical fibers in low loss by using a sleeve made of ceramic and processing the outer periphery of a ferrule with micron-order precision (see, for example, Patent Document 3). Furthermore, there is proposed an optical fiber connector that integrates an optical fiber and a ferrule using a shrink tube so as to prevent an optical fiber connection state from significantly changing even when ferrules are deformed due to long-term connection therebetween (see Patent Document 4).

### CITATION LIST

### Patent Document

[Patent Document 1] Japanese patent application laid-open No. 2004-004222
[Patent Document 2] Japanese patent application laid-open No. S61-003106
[Patent Document 3] Japanese patent application laid-open No. 2002-250840
[Patent Document 4] Japanese patent application laid-open No. 2005-010420

### SUMMARY OF THE INVENTION

### Problem to be Solved by the Invention

In the above-described conventional optical fiber connectors, a ferrule, a sleeve, and the like are used to align optical fiber core wires to thereby make leading ends thereof abut against each other. However, even in such a case, leading ends of optical fiber core wires may be misaligned due to the manufacturing tolerance of components constituting the optical fiber connector or due to an external force applied to optical fibers, which may make optical fiber connection loss likely to occur.

Along with rapid diffusion of smartphones and IoT, demand for high-speed communication increases more and more. In communication facilities such as data centers, an extremely large number of optical fiber cables are installed, and it is necessary to provide optical fiber connectors as many as the number of optical fiber cables. Thus, miniaturization of the optical fiber connector is a critical issue, and thus optical fiber connection technology utilizing a magnetic force is expected to significantly contribute to miniaturization of the optical fiber connector. For such optical fiber connection utilizing a magnetic force, an optical fiber connector with low connection loss and high reliability is required.

It is therefore an object of the present invention to provide an optical fiber connector connecting optical fibers utilizing a magnetic force, capable of making leading ends of optical fiber core wires less likely to be misaligned to reduce optical fiber connection loss.

### Means for Solving the Problem

To solve the above problem, an optical fiber connector according to the present invention includes: an adaptor having an insertion hole; a first plug holding a first optical fiber; and a second plug holding a second optical fiber, wherein the adaptor has first and second attracting surfaces having, respectively, one and the other insertion ports of the insertion hole, the first plug has a first attracted surface that receives, from the first attracting surface, an attractive force generated by a magnetic force when the first optical fiber is inserted into the one insertion port, one of the first attracting surface and the first attracted surface is constituted by a permanent magnet, and the other one thereof is constituted by a magnetic body, in a state where leading ends of the respective first and second optical fibers are connected to each other in the insertion hole, at least an outer peripheral edge of the first attracted surface does not continuously contact the corresponding outer peripheral edge of the first attracting surface.

According to the present invention, the outer peripheral edge of the attracted surface of the first plug is separated from the outer peripheral edge of the attracting surface of the adaptor. That is, the outer peripheral edge of the magnetic body constituting one of the attracting and attracted surfaces can be separated from the outer peripheral edge of the permanent magnet constituting the other one of the attracting and attracted surfaces. A large magnetic gradient is exhibited around the outer peripheral edge of the permanent magnet, so that when the outer peripheral edge of the permanent magnet and the outer peripheral edge of the magnetic body are close to each other, a large force is applied to the outer peripheral edge of the magnetic body; however, by thus separating the outer peripheral edge of the magnetic body from the outer peripheral edge of the permanent magnet, the magnetic gradient around the outer peripheral edge of the magnetic body can be reduced, whereby a force generated around the outer peripheral edge of the magnetic body by the magnetic gradient can be reduced. Thus, when the first plug or adaptor is displaced in a direction orthogonal to a connector axis direction, not only the occurrence of a magnetic force in a direction increasing the displacement can be suppressed, but also a magnetic force in a direction reducing the displacement can be generated. This can achieve an optical fiber connector capable of making axial misalignment of the optical fiber less likely to occur to reduce optical fiber connection loss.

In the present invention, it is preferable that a force in a direction increasing axial misalignment that one of the adaptor and the first plug receives from the other one thereof when a center axis of the first plug is displaced from a center axis of the adaptor is 22 mN or less. This can achieve an optical fiber connector capable of making axial misalignment of the optical fiber less likely to occur to reduce optical fiber connection loss.

In a state where the leading ends of the respective first and second optical fibers are connected to each other, the entire surface of the first attracted surface is preferably not in contact with the first attracting surface. In this case, a gap may be provided between the first attracted surface and the first attracting surface. With this configuration, it is possible to achieve an optical fiber connector capable of sufficiently suppressing axial misalignment of the optical fiber to sufficiently reduce optical fiber connection loss while generating a magnetic force required for PC connection.

In the present invention, it is preferable that the first attracted surface has the same shape and size as those of the first attracting surface, and a first gap between the first attracting surface and the first attracted surface is 0.5 μm or more. When the first attracted surface has the same shape and size as the first attracting surface, a magnetic force that may cause axial misalignment of the optical fiber is likely to occur between the first attracting surface and the first attracted surface. However, when a gap of 0.5 μm or more is provided between the first attracting surface and the first attracted surface, the occurrence of a magnetic force that may cause such axial misalignment can be suppressed to thereby making it possible to reduce optical fiber connection loss.

It is preferable that an area S of the first attracting surface and the first gap G satisfy a relation of 0.08 [1/m]≤G/S≤38 [1/m]. By satisfying this, it is possible to sufficiently suppress the occurrence of a magnetic force that may cause axial misalignment of the optical fiber while generating a magnetic force necessary for PC connection that the first attracted surface receives from the first attracting surface to thereby reduce optical fiber connection loss.

In the present invention, the outer peripheral edge of at least one of the first attracting surface and the first attracted surface is preferably chamfered. In this case, the chamfering shape may be a flat surface (C-surface) or a curved surface (R-surface). The chamfering shape may not necessarily be the C-surface or R-surface, and some manufacturing variation is allowed. The chamfering effects are as follows: (1) when the edge of the permanent magnet exhibiting a steep magnetic gradient is chamfered, the magnetic body becomes hard to be attracted to the edge of the permanent magnet; (2) when the edge of the magnetic body is chamfered, a part of the magnetic body that is strongly attracted to the permanent magnet is reduced in area; and 3) both the effects (1) and (2). By the above effects (1) to (3), when the attracting surface or attracted surface is displaced in a direction perpendicular to the connector axis direction, a magnetic force in a direction increasing the displacement is reduced or not generated at all, or conversely a magnetic force in a direction reducing the displacement is generated. Thus, it is possible to achieve an optical fiber connector capable of making axial misalignment of the optical fiber much less likely to occur to further reduce optical fiber connection loss.

In the present invention, a non-magnetic body is preferably provided between the first attracting surface and the first attracted surface. In this case, the first attracted surface can be reliably separated from the first attracting surface.

In the present invention, the position of the outer peripheral edge of the first attracted surface in the in-plane direction is preferably displaced from the corresponding outer peripheral edge of the first attracting surface. In this case, the outer peripheral shape of the first attracted surface may be the same as the outer peripheral shape of the first attracting surface. Further, the outer peripheral shape of the first attracted surface may be similar to the outer peripheral shape of the first attracting surface. With this configuration, the edge of the magnetic body can be further separated from the edge of the permanent magnet exhibiting a large magnetic gradient, making it possible to reduce an attractive force to the edge of the permanent magnet.

In a state where the leading ends of the respective first and second optical fibers are connected to each other, preferably, the first attracted surface has an area contacting the first attracting surface, and the outer peripheral edge of at least one of the first attracting surface and the first attracted surface is chamfered. In this case, the outer peripheral edges of both the first attracting surface and the first attracted surface are preferably chamfered. Further, in this case, the chamfering width of the outer peripheral edge is preferably 50 μm or more and 400 μm or less. Chamfering the outer peripheral edge of at least one of the first attracting surface and the first attracted surface suppresses the occurrence of a magnetic force that may cause axial misalignment of the optical fiber even when the first attracting surface and the first attracted surface contact each other to make it possible to reduce optical fiber connection loss.

In a state where the leading ends of the respective first and second optical fibers are connected to each other, preferably, the first attracted surface has an area contacting the first attracting surface, and the position of the outer peripheral edge of the first attracted surface in the in-plane direction is displaced from the corresponding outer peripheral edge of the first attracting surface.

According to the present invention, the edge positions of the contours of the respective attracted and attracting surfaces do not coincide with each other but are slightly displaced from each other, so that the edge of the magnetic body can be separated from the edge of the permanent magnet exhibiting a large magnetic gradient, making it possible to reduce an attractive force to the edge of the permanent magnet. Thus, when the first plug or adaptor is displaced in a direction perpendicular to the connector axis direction, not only the occurrence of a magnetic force in a direction increasing the displacement can be suppressed, but also a magnetic force in a direction reducing the displacement can be generated. This can achieve an optical fiber connector capable of making axial misalignment of the optical fiber less likely to occur to reduce optical fiber connection loss.

In the present invention, the first attracted surface preferably has the same outer peripheral shape as the first attracting surface. Further, the first attracted surface preferably has an outer peripheral shape similar to that of the first attracting surface. When the first attracted surface has the same outer peripheral shape as the first attracting surface, the position of the outer peripheral edge can be displaced over the entire periphery of the outer peripheral edge, and the first plug can be easily detached and attached from/to the adaptor.

In the present invention, the difference in position between the outer peripheral edge of the first attracted surface and the corresponding outer peripheral edge of the first attracting surface is preferably 0.1 mm or more and 1.5 mm or less. This can increase a magnetic force in a direction reducing the displacement. The above difference is more preferably 0.2 mm or more and 0.5 mm or less. This can generate a magnetic force in a direction correcting the displacement while generating a magnetic force required for PC connection.

The area ratio of the first attracted surface to the first attracting surface is preferably 0.18 or more and 4.29 or less. Alternatively, the difference in area of the first attracted surface with respect to the first attracting surface is preferably within ±5%. Thus, it is possible to generate a magnetic force in a direction correcting the displacement while generating a magnetic force required for PC connection.

The outer peripheral edge of the first attracted surface is preferably positioned outside the corresponding outer peripheral edge of the first attracting surface. This can increase a magnetic force in a direction reducing the displacement.

In the present invention, the outer peripheral edge of at least one of the first attracting surface and the first attracted surface is preferably chamfered. This allows the edge of the magnetic body to be separated from the edge of the permanent magnet exhibiting a large magnetic gradient.

In the present invention, the first attracting surface is preferably constituted by a permanent magnet, and the first attracted surface is preferably constituted by a magnetic body. When the permanent magnet is provided on the first plug side, the leading ends of optical fiber cables held by the first plug are attracted to each other or to a magnetic body such as iron around the first plug, so that careful handing is required so as not to allow the leading ends of the optical fiber cables to be attracted to the magnetic body around the first plug, resulting in inconvenience in terms of handling of the optical fiber cable. However, when the permanent magnet is provided on the adaptor side, and the plug is constituted by the magnetic body, the first plug holding the optical fiber cable is not attracted to the surrounding object, so that the optical fiber cable can be handled in the same manner as normal ones.

In the present invention, the second plug has a second attracted surface that receives, from the second attracting surface, an attractive force generated by a magnetic force when the second optical fiber is inserted into the other insertion port, one of the second attracting surface and the second attracted surface is constituted by a permanent magnet, and the other one thereof is constituted by a magnetic body, in a state where the leading ends of the respective first and second optical fibers are connected to each other in the insertion hole, at least an outer peripheral edge of the second attracted surface does not continuously contact the corresponding outer peripheral edge of the second attracting surface. Thus, the second plug can have the same configuration as the first plug, whereby it is possible to achieve an optical fiber connector capable of making axial misalignment of the second optical fiber less likely to occur to reduce optical fiber connection loss.

In the present invention, a force in a direction increasing axial misalignment that one of the adaptor and the second plug receives from the other one thereof when a center axis of the second plug is displaced from the center axis of the adaptor is preferably 22 mN or less. This can achieve an optical fiber connector capable of making axial misalignment of the optical fiber less likely to occur to reduce optical fiber connection loss.

In the present invention, in a state where the leading ends of the respective first and second optical fibers are connected to each other, the entire surface of the second attracted surface is preferably not in contact with the second attracting surface. In this case, a gap may be provided between the second attracted surface and the second attracting surface. With this configuration, it is possible to achieve an optical fiber connector capable of sufficiently suppressing axial misalignment of the optical fiber to sufficiently reduce optical fiber connection loss while generating a magnetic force required for PC connection.

In the present invention, it is preferable that the second attracted surface has the same shape and size as the second attracting surface, and a second gap between the second attracting surface and the second attracted surface is 0.5 μm or more. When the second attracted surface has the same shape and size as the second attracting surface, a magnetic force that may cause axial misalignment of the optical fiber is likely to occur between the second attracting surface and the second attracted surface. However, when a gap of 0.5 μm or more is provided between the second attracting surface and the second attracted surface, the occurrence of a magnetic force that may cause such axial misalignment can be suppressed, thus making it possible to reduce optical fiber connection loss.

It is preferable that an area S of the second attracting surface and the second gap G satisfy a relation of 0.08≤G/S≤38 [1/m]. By satisfying this, it is possible to sufficiently suppress the occurrence of a magnetic force that may cause axial misalignment of the optical fiber while generating a magnetic force necessary for PC connection that the second attracted surface receives from the second attracting surface to thereby reduce optical fiber connection loss.

In the present invention, the outer peripheral edge of at least one of the second attracting surface and the second attracted surface is preferably chamfered. In this case, the chamfering shape may be a flat surface (C-surface) and a curved surface (R-surface). The chamfering effects are as follows: (1) when the edge of the permanent magnet exhibiting a steep magnetic gradient is chamfered, the magnetic body becomes hard to be attracted to the edge of the permanent magnet; (2) when the edge of the magnetic body is chamfered, a part of the magnetic body that is strongly attracted to the permanent magnet is reduced in area; and 3) both the effects (1) and (2). By the above effects (1) to (3), when the attracting surface or attracted surface is displaced in a direction perpendicular to the connector axis direction, a magnetic force in a direction increasing the displacement is reduced or not generated at all, or conversely a magnetic force in a direction reducing the displacement is generated. Thus, it is possible to achieve an optical fiber connector capable of making axial misalignment of the optical fiber much less likely to occur to further reduce optical fiber connection loss.

In the present invention, a non-magnetic body is preferably provided between the second attracting surface and the second attracted surface. In this case, the second attracted surface can be reliably separated from the second attracting surface.

In the present invention, the position of the outer peripheral edge of the second attracted surface in the in-plane direction is preferably displaced from the corresponding outer peripheral edge of the second attracting surface. In this case, the outer peripheral shape of the second attracted surface may be the same as the outer peripheral shape of the second attracting surface. Further, the outer peripheral shape of the second attracted surface may be similar to the outer peripheral shape of the second attracting surface. With this configuration, the edge of the magnetic body can be further separated from the edge of the permanent magnet exhibiting a large magnetic gradient, making it possible to reduce an attractive force to the edge of the permanent magnet.

In a state where the leading ends of the respective first and second optical fibers are connected to each other, preferably, the second attracted surface has an area contacting the second attracting surface, and the outer peripheral edge of at least one of the second attracting surface and the second attracted surface is chamfered. In this case, the outer peripheral edges of both the second attracting surface and the second attracted surface are preferably chamfered. Further, in this case, the chamfering width of the outer peripheral edge is preferably 50 μm or more and 400 μm or less. Chamfering the outer peripheral edge of at least one of the second attracting surface and the second attracted surface suppresses the occurrence of a magnetic force that may cause axial misalignment of the optical fiber even when the second attracting surface and the second attracted surface contact each other to make it possible to reduce optical fiber connection loss.

In a state where the leading ends of the respective first and second optical fibers are connected to each other, preferably, the second attracted surface has an area contacting the second attracting surface, and the position of the outer peripheral edge of the second attracted surface in the in-plane direction is displaced from the corresponding outer peripheral edge of the second attracting surface.

According to the present invention, the edge positions of the contours of the respective attracted and attracting surfaces do not coincide with each other but are slightly displaced from each other, so that the edge of the magnetic body can be separated from the edge of the permanent magnet exhibiting a large magnetic gradient, making it possible to reduce an attractive force to the edge of the permanent magnet. Thus, when the second plug or adaptor is displaced in a direction perpendicular to the connector axis direction, not only the occurrence of a magnetic force in a direction increasing the displacement can be suppressed, but also a magnetic force in a direction reducing the displacement can be generated. This can achieve an optical fiber connector capable of making axial misalignment of the optical fiber less likely to occur to reduce optical fiber connection loss.

In the present invention, the second attracted surface preferably has the same outer peripheral shape as the second attracting surface. Further, the second attracted surface preferably has an outer peripheral shape similar to that of the second attracting surface. When the first attracted surface has the same outer peripheral shape as the first attracting surface, the position of the outer peripheral edge can be displaced over the entire periphery of the outer peripheral edge, and the first plug can be easily detached from and attached to the adaptor.

In the present invention, the difference in position between the outer peripheral edge of the second attracted surface and the corresponding outer peripheral edge of the second attracting surface is preferably 0.1 mm or more and 1.5 mm or less. This can increase a magnetic force in a direction reducing the displacement. The above difference is more preferably 0.2 mm or more and 0.5 mm or less. This can generate a magnetic force in a direction correcting the displacement while generating a magnetic force required for PC connection.

The area ratio of the second attracted surface to the second attracting surface is preferably 0.18 or more and 4.29 or less. Alternatively, the difference in area of the second attracted surface with respect to the second attracting surface is preferably within ±5%. Thus, it is possible to generate a magnetic force in a direction correcting the displacement while generating a magnetic force required for PC connection.

The outer peripheral edge of the second attracted surface is preferably positioned outside the corresponding outer peripheral edge of the second attracting surface. This can increase a magnetic force in a direction reducing the displacement.

In the present invention, the outer peripheral edge of at least one of the second attracting surface and the second attracted surface is preferably chamfered. This allows the edge of the magnetic body to be separated from the edge of the permanent magnet exhibiting a large magnetic gradient.

In the present invention, the second attracting surface is preferably constituted by a permanent magnet, and the second attracted surface is preferably constituted by a magnetic body. When the permanent magnet is provided on the second plug side, the leading ends of optical fiber cables held by the second plug are attracted to each other or to a magnetic body such as iron around the second plug, so that careful handing is required so as not to allow the leading ends of the optical fiber cables to be attracted to the magnetic body around the second plug, resulting in inconvenience in terms of handling of the optical fiber cable. However, when the permanent magnet is provided on the adaptor side, and the plug is constituted by the magnetic body, the second plug holding the optical fiber cable is not attracted to the surrounding object, so that the optical fiber cable can be handled in the same manner as normal ones.

In the present invention, it is preferable that the first attracting surface differs in shape from the second attracting surface, and the first attracted surface differs in shape from the second attracted surface. This facilitates discrimination between the first and second plugs.

In the present invention, it is preferable that the first plug holds a plurality of the first optical fibers, the second plug holds the second optical fibers as many as the number of the first optical fibers, and the adaptor has the insertion holes as many as the number of the first optical fibers and connects leading ends of the plurality of first optical fibers and leading ends of the plurality of second optical fibers together. Thus, the present invention can be applied to an optical fiber connector of multicore type.

### Advantageous Effects of the Invention

According to the present invention, there can be provided an optical fiber connector connecting optical fibers utilizing a magnetic force, capable of making leading ends of optical fiber core wires less likely to be misaligned to reduce optical fiber connection loss.

### BRIEF DESCRIPTION OF THE DRAWINGS

FIG. 1 is a schematic perspective view illustrating a configuration of an optical fiber connector according to a first embodiment of the present invention.

FIG. 2 is a schematic cross-sectional side view illustrating a structure of the optical fiber connector according to the first embodiment.

FIGS. 3A and 3B are schematic perspective views illustrating configurations of an adaptor and first and second plugs constituting the optical fiber connector, in which FIG. 3A illustrates the adaptor, and FIG. 3B illustrates the first and second plugs.

FIGS. 4A to 4D are views for explaining a magnetic force generated between a permanent magnet and a magnetic body, and particularly, FIG. 4D is a view for explaining the magnetic force generated in which the attracting surface and the attracted surface are not in contact with each other.

FIG. 5 is a schematic cross-sectional side view of an optical fiber connector according to a second embodiment of the present invention, which illustrates a modification of the adaptor 10.

FIG. 6 is a schematic cross-sectional side view illustrating a structure of an optical fiber connector according to a third embodiment of the present invention.

FIG. 7 is a schematic cross-sectional side view illustrating a structure of an optical fiber connector according to a fourth embodiment of the present invention.

FIG. 8 is a schematic cross-sectional side view illustrating a structure of an optical fiber connector according to a fifth embodiment of the present invention.

FIG. 9 is a schematic cross-sectional side view illustrating a structure of an optical fiber connector according to a sixth embodiment of the present invention.

FIG. 10 is a schematic cross-sectional side view illustrating a structure of an optical fiber connector according to a seventh embodiment of the present invention.

FIG. 11 is a schematic perspective view illustrating a configuration of an optical fiber connector according to an eighth embodiment of the present invention.

FIG. 12 is a schematic cross-sectional side view illustrating a structure of the optical fiber connector according to the eighth embodiment.

FIGS. 13A to 13D are views for explaining a magnetic force generated between a permanent magnet and a magnetic body, and particularly, FIG. 13D is a view for explaining the magnetic force generated in which the attracting surface is larger than the attracted surface.

FIGS. 14A to 14F are views illustrating variations of the relation between the shape of the attracting surface of the adaptor 10 and the shape of the attracted surface of each of the first and second plugs 20A and 20B.

FIG. 15 is a cross-sectional side view of an optical fiber connector according to a ninth embodiment of the present invention, which illustrates a modification of the adaptor 10.

FIG. 16 is a schematic cross-sectional side view illustrating a structure of an optical fiber connector according to a tenth embodiment of the present invention.

FIG. 17 is a schematic cross-sectional side view illustrating a structure of an optical fiber connector according to an eleventh embodiment of the present invention.

FIG. 18 is a schematic cross-sectional side view illustrating a structure of an optical fiber connector according to a twelfth embodiment of the present invention.

FIG. 19 is a schematic cross-sectional side view illustrating a structure of an optical fiber connector according to a thirteenth embodiment of the present invention.

FIG. 20 is a schematic cross-sectional view illustrating a structure of an optical fiber connector according to a fourteenth embodiment of the present invention.

FIG. 21 is a schematic cross-sectional view illustrating a structure of an optical fiber connector according to a fifteenth embodiment of the present invention.

FIGS. 22A and 22B are schematic perspective views illustrating a structure of an optical fiber connector according to a sixteenth embodiment of the present invention, in which FIG. 22A illustrates a state where the first and second plugs 20A and 20B are connected to the adaptor 10, and FIG. 22B illustrates a state where the first plug 20A is removed from the adaptor 10.

FIG. 23 is a graph illustrating a relation between a displacement amount [μm] in the X-direction of the adaptor and a displacement force [mN] in the X-direction acting on the adaptor.

FIG. 24 is a graph illustrating a relation between the width of a gap between the attracting surface and the attracted surface and a connection loss [mN] of the optical fiber that can be caused by a magnetic force.

FIG. 25 is a graph illustrating a relation between the width of a gap between the attracting surface and the attracted surface and a pressing force Z_{force} [N] generated by a magnetic force.

FIG. 26 is a graph illustrating a relation between a displacement amount [μm] in the X-direction of the adaptor and a displacement force [mN] in the X-direction acting on the adaptor 10.

FIG. 27 is a graph illustrating a relation between the C-chamfering width [μm] and the connection loss [dB].

FIG. 28 is a graph illustrating a relation between the R-chamfering width [μm] and the connection loss [dB].

FIG. 29 is a graph illustrating a relation between the C-chamfering width [μm] and a pressing force Z_{force [N]} acting in the center axis direction (z-axis direction).

FIGS. 30A to 30D are schematic perspective views illustrating optical fiber connector having a square connection surface according to Examples 1-1, 1-2, 1-3 and a Comparative Example 1-1.

FIG. 31 is a graph showing a relation between a displacement amount [mm] in the X-direction of the adaptor of the optical fiber connector according to Examples 1-1, 1-2 and 1-3 and Comparative Examples 1-1, 1-2 and 1-3 and a displacement force [mN] acting on the adaptor.

FIGS. 32A to 32C are schematic perspective views illustrating a structure of the optical fiber connector according to Examples 2-1 and 2-2 and a Comparative Example 2.

FIG. 33 is a graph showing a relation between a displacement amount [mm] in the X-direction of the adaptor of the optical fiber connector according to Examples 2-1 and 2-2 and Comparative Example 2 and a displacement force [mN] acting on the adaptor.

FIGS. 34A to 34D are schematic perspective views illustrating a structure of the optical fiber connector according to Examples 3-1, 3-2 and 3-3 and a Comparative Example 3.

FIG. 35 is a graph showing a relation between a displacement amount [mm] in the X-direction (short side direction) of the adaptor of the optical fiber connector according to Examples 3-1, 3-2 and 3-3 and Comparative Example 3 and a displacement force [mN] acting on the adaptor.

FIG. 36 is a graph showing a relation between a displacement amount [mm] in the Y-direction (long side direction) of the adaptor of the optical fiber connector according to Examples 3-1, 3-2 and 3-3 and Comparative Example 3 and a displacement force [mN] acting on the adaptor.

FIGS. 37A to 37C are schematic perspective views illustrating a structure of the optical fiber connector according to Examples 4-1 and 4-2 and a Comparative Example 4.

FIG. 38 is a graph showing a relation between a displacement amount [mm] in the Y-direction (short axis direction) of the adaptor of the optical fiber connector according to Examples 4-1, 4-2 and 4-3 and Comparative Example 4 and a displacement force [mN] acting on the adaptor.

FIG. 39 is a graph showing a relation between a displacement amount [mm] in the Y-direction (long axis direction) of the adaptor of the optical fiber connector according to Examples 4-1, 4-2 and 4-3 and Comparative Example 4 and a displacement force [mN] acting on the adaptor.

FIG. 40 is a graph showing a relation between a displacement amount [mm] in the X-direction (short axis direction) of the adaptor of the optical fiber connector according to Examples 5-1, 5-2 and 5-3 and Comparative Example 5 and a displacement force [mN] acting on the adaptor.

FIG. 41 is a graph showing a relation between a displacement amount [mm] of the adaptor and a displacement force [mN] generated at that time.

### MODE FOR CARRYING OUT THE INVENTION

Hereinafter, preferred embodiments of the present invention will be described in detail with reference to the accompanying drawings.

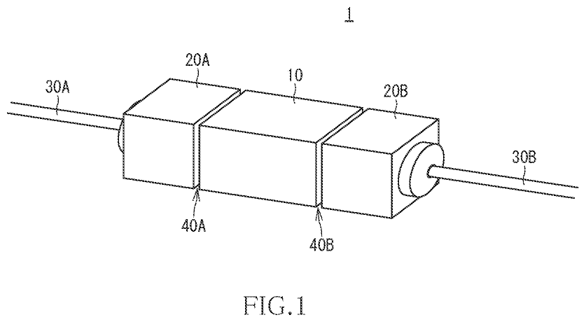

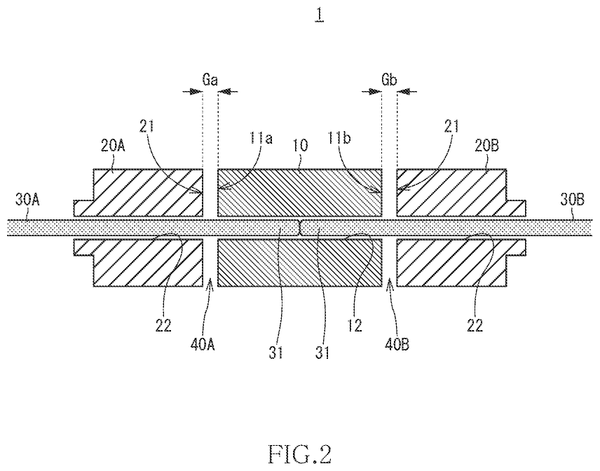

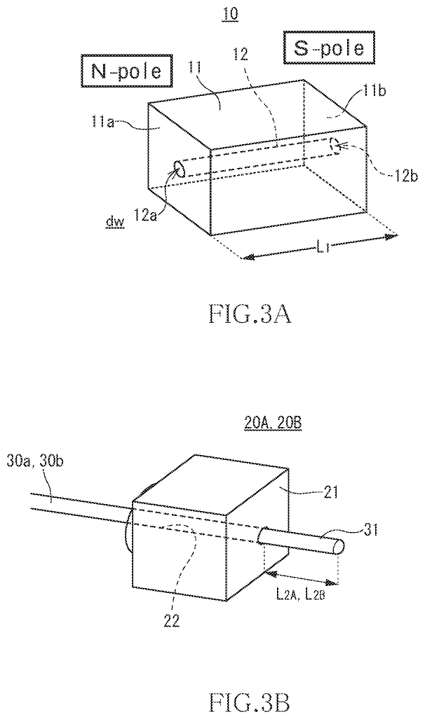

FIG. 1 is a schematic perspective view illustrating the configuration of an optical fiber connector according to a first embodiment of the present invention. FIG. 2 is a schematic cross-sectional side view illustrating the structure of the optical fiber connector according to the first embodiment. FIGS. 3A and 3B are schematic perspective views illustrating the configurations of an adaptor and first and second plugs constituting the optical fiber connector. FIG. 3A illustrates the adaptor, and FIG. 3B illustrates the first and second plugs.

As illustrated in FIG. 1 and FIGS. 2A and 2B, an optical fiber connector 1 is a device for connecting leading ends of two respective optical fibers 30A and 30B and includes an adaptor 10 having an insertion hole 12 for the optical fibers 30A and 30B, a first plug 20A retaining the first optical fiber 30A inserted into one insertion port 12a of the insertion hole 12, and a second plug 20B retaining the second optical fiber 30B inserted into the other insertion port 12b of the insertion hole 12. Although not particularly limited, the optical fibers 30A and 30B can each be, for example, a single mode fiber having a mode field diameter of 9 μm and a clad diameter of 125 μm.

As illustrated in FIG. 3A, the adaptor 10 has a quadrangular columnar base body 11, and the insertion hole 12 penetrates the base body 11 from one end surface 11a thereof in the longitudinal direction to the other end surface 11b. Accordingly, the one insertion port 12a of the insertion hole 12 is formed in the one end surface 11a of the base body 11, and the other insertion port 12b of the insertion hole 12 is formed in the other end surface 11b of the base body 11 positioned on the side opposite the one end surface 11a.

In the present embodiment, the base body 11 is entirely constituted by a permanent magnet with the one end surface 11a side thereof as an N-pole and the other end surface 11b side as an S-pole. The one end surface 11a of the base body 11 constitutes a first attracting surface that faces the first plug 20A and imparts an attractive force thereto, and the other end surface 11b of the base body 11 constitutes a second attracting surface that faces the second plug 20B and imparts an attractive force thereto. The permanent magnet is preferably a neodymium magnet that exhibits a strong magnet force even in a small size.

As illustrated in FIG. 3B, the first and second plugs 20A and 20B are components for fixing the optical fibers 30A and 30B to the adaptor 10. Although the first and second plugs 20A and 20B have the same configuration in the present embodiment, they may have mutually different configurations as will be described later.

The first plug 20A has a through hole 22, and the first optical fiber 30A is inserted into the through hole 22. A leading end portion 31 of the first optical fiber 30A protrudes from a front-end surface 21 of the first plug 20A, and in this state the first optical fiber 30A is fixed by the first plug 20A. A protruding amount L_{2A} of the first optical fiber 30A from the front-end surface 21 of the first plug 20A is set slightly larger than half a length L₁ of the adaptor 10 in the center axis direction thereof.

Like the first plug 20A, the second plug 20B has a through hole 22, and the second optical fiber 30B is inserted into the through hole 22. A leading end portion 31 of the second optical fiber 30B protrudes from a front-end surface 21 of the second plug 20B, and in this state the second optical fiber 30B is fixed by the second plug 20B. A protruding amount L_{2B} of the second optical fiber 30B from the front-end surface 21 of the second plug 20B is set slightly larger than half the length L₁ of the adaptor 10 in the center axis direction thereof.

Although not particularly limited, the entire outer dimension (height×width×length) of the optical fiber connector 1 can be set to about 3 mm×3 mm×10 mm. A conventional LC-type optical fiber connector has an outer dimension of, for example, 7 mm×10 mm×30 mm, so that it can be said that the optical fiber connector 1 according to the present embodiment is extremely small.

In the present embodiment, the first and second plugs 20A and 20B are each constituted by a magnetic body (soft magnet) such as a ferrite-based stainless steel. Thus, the first and second plugs 20A and 20B are attracted to contact the adaptor 10 by the magnetic force of the permanent magnet constituting the adaptor 10. At the same time, a pressing force that pushes the first and second optical fibers 30A and 30B into the adaptor 10 is generated. The front-end surface 21 of the first plug 20A constitutes an attracted surface (first attracted surface) that faces the one end surface 11a (first attracting surface) of the adaptor 10 and receives an attractive force generated by a magnetic force from the adaptor 10. On the other hand, the front-end surface 21 of the second plug 20B constitutes an attracted surface (second attracted surface) that faces the other end surface 11b (second attracting surface) of the adaptor 10 and receives an attractive force generated by a magnetic force from the adaptor 10. Although the first and second plugs 20A and 20B are each preferably a single magnetic member, they may each be constituted by a combination of a plurality of magnetic components.

In the present embodiment, the leading end portions 31 of the respective first and second optical fibers 30A and 30B protrude from the front-end surfaces 21 of the respective first and second plugs 20A and 20B and are inserted into the insertion hole 12 of the adaptor 10. The attracting position between the adaptor 10 and each of the first and second plugs 20A and 20B is separated from the connection position between the leading ends of the first and second optical fibers 30A and 30B. This helps to maintain adhesion between the end surfaces at the leading ends of the optical fibers when an external force is applied to the leading ends of the optical fibers in a vertical direction with respect to the first and second plugs 20A and 20B or first and second optical fibers 30A and 30B.

The front-end surfaces 21 (first and second attracted surfaces) of the respective first and second plugs 20A and 20B each have the same shape and size (outer dimension) as each of the one and the other end surfaces 11a and 11b of the adaptor 10. For example, the one and the other end surfaces 11a and 11b of the adaptor 10 and the front-end surfaces 21 of the respective first and second plugs 20A and 20B each have a square shape of 3 mm×3 mm. Accordingly, the position of the outer peripheral edge of the front-end surface 21 of the first plug 20A is close to the position of the outer peripheral edge of the one end surface 11a of the adaptor 10. Similarly, the position of the outer peripheral edge of the front-end surface 21 of the second plug 20B is close to the position of the outer peripheral edge of the other end surface 11b of the adaptor 10. Unless otherwise specified, the “outer peripheral edge” refers to the edge of the side surface on the front-end surface 21 side of the first plug 20A (second plug 20B) or the edge of the side surface on the end surface 11a (11b) side of the adaptor 10.

As described above, the protruding amount L_{2A} of the first optical fiber 30A from the first plug 20A and the protruding amount L_{2B} of the second optical fiber 30B from the second plug 20B are each slightly larger than half the length L₁ of the adaptor 10 (L_{2A}>L₁/2, L_{2B}>L₁/2). Thus, as illustrated, in a state where the first and second optical fibers 30A and 30B are inserted into the insertion hole of the adaptor 10 and connected to each other at their leading ends, at least the front-end surface 21 of one of the first and second plugs 20A and 20B does not contact the one end surface 11a or the other end surface 11b of the adaptor 10 with a slight gap 40A or 40B interposed therebetween. However, a magnetic force is exerted between the adaptor 10 and the first and second plugs 20A and 20B, and thus the front-end surfaces 21 of the first and second plugs 20A and 20B are attracted to the adaptor 10 side, thereby achieving reliable connection between the leading end portions 31 of the first and second optical fibers 30A and 30B.

The gap 40A between the front-end surface 21 of the first plug 20A and the one end surface 11a of the adaptor 10 and/or the gap 40B between the front-end surface 21 of the second plug 20B and the other end surface 11b of the adaptor 10 serve to prevent displacement of the first and second plugs 20A and 20B. When the outer peripheral edge of each of the end surfaces 11a and 11b of the adaptor 10 and the outer peripheral edge of the front-end surface 21 of each of the first and second plugs 20A and 20B almost coincide in shape with each other and substantially continuously contact each other, a magnetic force by which the edge of a magnetic body gets away from the edge of a permanent magnet exhibiting a large magnetic gradient is likely to act. This may generate a magnetic force in a direction increasing the displacement to make it likely to cause displacement in a direction perpendicular to the connector axis direction. However, when the attracted surface of each of the first and second plugs 20A and 20B is separated from (although close to) the attracting surface of the adaptor 10 even slightly and does not substantially continuously contact it, the occurrence of such a magnetic force that may increase the displacement can be suppressed, thus making it possible to prevent axial misalignment between the core wires of the optical fibers.

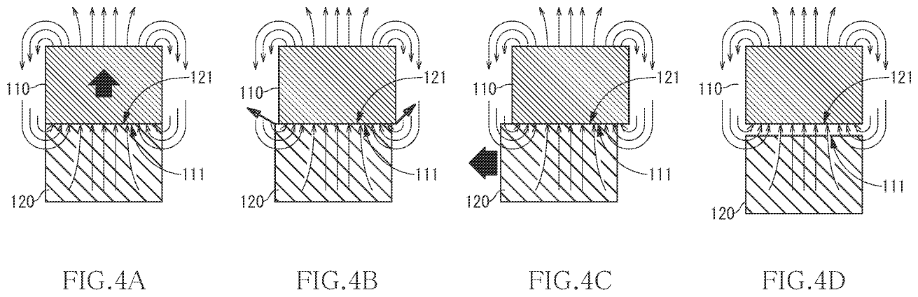

FIGS. 4A to 4D are views for explaining a magnetic force generated between a permanent magnet and a magnetic body.

As illustrated in FIG. 4A, when an attracting surface 111 of a permanent magnet 110 and an attracted surface 121 of a magnetic body 120, which coincide with each other in planar shape and size, contact each other in a completely overlapping state, magnetic symmetry is exquisitely balanced, making it possible to maintain a state where the attracting surface 111 and the attracted surface 121 completely overlap each other. However, as illustrated in FIG. 4B, when the position of the magnetic body 120 with respect to the permanent magnet 110 is displaced even slightly, a magnetic force acts in a direction increasing the displacement, resulting in increase in the displacement therebetween as illustrated in FIG. 4C.

On the other hand, as illustrated in FIG. 4D, when the attracted surface 121 of the magnetic body 120 is separated from the attracting surface 111 of the permanent magnet 110, the edge of the permanent magnet 110 and the edge of the magnetic body 120 are separated and do not substantially continuously contact each other, so that the occurrence of a magnetic force acting in a direction increasing the displacement of the magnetic body 120 can be suppressed to make it possible to prevent the magnetic body 120 from being displaced.

A width Ga (first gap) of the gap 40A between the front-end surface 21 of the first plug 20A and the one end surface 11a of the adaptor 10 and a width Gb (second gap) of the gap 40B between the front-end surface 21 of the second plug 20B and the other end surface 11b of the adaptor 10 are each preferably 0.5 μm or more and 240 μm or less and more preferably 10 μm or more and 240 μm or less. When the widths Ga and Gb of the gaps 40A and 40B are each 0.5 μm or more, it is possible to suppress displacement of the first and second plugs 20A and 20B with respect to the adaptor 10. Further, when the widths Ga and Gb of the gaps 40A and 40B are each 10 μm or more, it is possible to reliably form the gaps 40A and 40B while absorbing mounting error and deformation of the first and second optical fibers 30A and 30B with respect to the first and second plugs 20A and 20B and further to reliably connect the end surfaces of the first and second optical fibers 30A and 30B while suppressing axial misalignment between the first and second optical fibers 30A and 30B. Furthermore, when the widths Ga and Gb of the gaps 40A and 40B are each 240 μm or less, it is possible to apply a predetermined pressing force to the first and second optical fibers 30A and 30B while ensuring a sufficient magnetic force.

The permanent magnet constituting the adaptor 10 preferably applies a pressing force of 1N or more to the first and second optical fibers 30A and 30B integrated with the respective first and second plugs 20A and 20B. By applying a pressing force of 1N or more to the first and second optical fibers 30A and 30B, the end surfaces of the first and second optical fibers 30A and 30B are elastically deformed to be tightly fitted to each other, thus achieving a reliable connection between the end surfaces of the optical fiber core wires.

To apply a pressing force of 1N or more to the first and second optical fibers 30A and 30B, it is preferable to set a ratio G/S of the width G of the gap to an area S of the attracting surface of the adaptor 10 constituted by a permanent magnet) to 0.08 or more and 38 or less (0.08 [1/m]≤G/S≤38 [1/m]). When the G/S is 0.08 [1/m] or more, the occurrence of a magnetic force that may increase the displacement with respect to the adaptor 10 can be suppressed, whereby it is possible to suppress axial misalignment between the optical fiber core wires to reduce optical fiber connection loss. Further, when the G/S is 38 [1/m] or less, it is possible to ensure a magnetic force required to apply a pressing force for PC connection, thereby making it possible to prevent decrease in optical fiber connection loss.

As described above, the optical fiber connector 1 according to the present embodiment includes the adaptor 10 constituted by a permanent magnet and first and second plugs 20A and 20B each constituted by a magnetic body and is configured such that in a state where the end surfaces of the first and second optical fibers 30A and 30B are connected to each other in the adaptor 10, the attracted surface of each of the first and second plugs 20A and 20B does not contact the attracting surface of the adaptor 10 but is separated therefrom. This prevents the occurrence of a magnetic force that may cause axial misalignment between the optical fibers when the first and second plugs 20A and 20B are attracted and fixed to the adaptor 10, thus making it possible to reduce optical fiber connection loss.

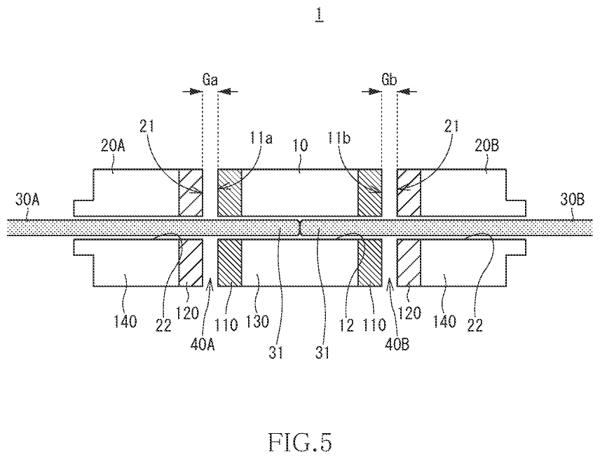

FIG. 5 is a schematic cross-sectional side view of an optical fiber connector according to a second embodiment of the present invention, which illustrates a modification of the adaptor 10.

As illustrated in FIG. 5, in the optical fiber connector 1 according to the present embodiment, only both end portions of the adaptor 10 including the one and the other end surfaces 11a and 11b are constituted by the permanent magnet 110, while a center portion 130 thereof is constituted by a non-magnetic body. Further, in each of the first and second plugs 20A and 20B, only the front portion including the front-end surface 21 is constituted by the magnetic body 120, while the rear portion is constituted by a non-magnetic body 140. Other configurations are the same as those of the first embodiment.

A material of the non-magnetic body constituting the center portion 130 of the adaptor 10 and a material of the non-magnetic body 140 constituting the rear portions of the respective first and second plugs 20A and 20B may be the same or different and is non-magnetic metal, resin, ceramic, or the like. Thus, the adaptor 10 may be constituted only partially by the permanent magnet 110, and the first and second plugs 20A and 20B may each be constituted only partially by the magnetic body 120. According to the present embodiment, it is possible to achieve reduction in weight and cost of the adaptor 10 and first and second plugs 20A and 20B in addition to the same effects as those obtained in the first embodiment.

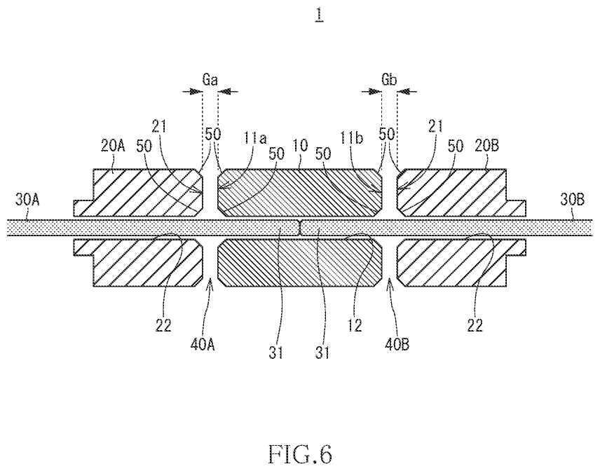

FIG. 6 is a schematic cross-sectional side view illustrating the structure of an optical fiber connector according to a third embodiment of the present invention.

As illustrated in FIG. 6, in the optical fiber connector 1 according to the present embodiment, the outer and inner peripheral edges of each of the one and the other end surfaces 11a and 11b of the adaptor 10 are chamfered. Further, the outer and inner peripheral edges of the front-end surface 21 of each of the first and second plugs 20A and 20B are also chamfered. A chamfered portion 50 is not particularly limited in shape and may be a curved surface (R-surface) or a 45-degree flat surface (C-surface).

When the profile of the attracting surface of the permanent magnet and the profile of the attracted surface of the magnetic body coincide with each other as described above, a magnetic force by which the edge of a magnetic body gets away from the edge of the permanent magnet exhibiting a large magnetic gradient is likely to act. This may generate a magnetic force in a direction increasing the displacement to make it likely to cause displacement in a direction perpendicular to the connector axis direction. However, when the outer and inner peripheral edges of each of the attracting and attracted surfaces are chamfered, the occurrence of such a magnetic force that may increase the displacement can be suppressed, thus making it possible to prevent axial misalignment between the core wires of the optical fibers.

In the present embodiment, the chamfered portion 50 is formed at each of the one and the other end surfaces 11a and 11b of the adaptor 10 and at the front-end surface 21 of each of the first and second plugs 20A and 20B; however, the chamfered portion 50 may be formed only in the first and second plugs 20A and 20B with the chamfered shape of the adaptor 10 omitted. Conversely, the chamfered portion 50 may be formed only in the adaptor 10 with the chamfered shape of each of the first and second plugs 20A and 20B omitted. Further, as illustrated, the attracting surface of the adaptor 10 and the attracted surface of each of the first and second plugs 20A and 20B may be chamfered at both the outer and inner peripheral edges, only at the outer peripheral edge, or only at the inner peripheral edge.

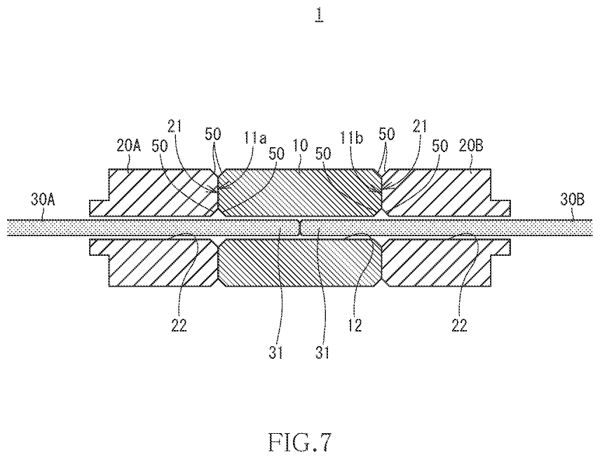

FIG. 7 is a schematic cross-sectional side view illustrating the structure of an optical fiber connector according to a fourth embodiment of the present invention.

As illustrated in FIG. 7, the optical fiber connector 1 according to the fourth embodiment is a modification of the third embodiment, in which the attracted surface contacts the attracting surface with no gap provided therebetween. Other configurations are the same as those of the optical fiber connector 1 according to the third embodiment, and the outer and inner peripheral edges of each of the attracting and attracted surfaces are chamfered. The chamfering width of the outer peripheral edge of each of the attracting and attracted surfaces is preferably 50 μm to 400 μm. An excessively small chamfering width results in failing to obtain chamfering effects, and an excessively large chamfering width results in reduction in an attracting force.

In the present embodiment, the chamfered portion 50 is formed at each of the one and the other end surfaces 11a and 11b of the adaptor 10 and at the front-end surface 21 of each of the first and second plugs 20A and 20B; however, the chamfered portion 50 may be formed only in the first and second plugs 20A and 20B with the chamfered shape of the adaptor 10 omitted. Conversely, the chamfered portion 50 may be formed only in the adaptor 10 with the chamfered shape of each of the first and second plugs 20A and 20B omitted. Further, as illustrated, the attracting surface of the adaptor 10 and the attracted surface of each of the first and second plugs 20A and 20B may be chamfered at both the outer and inner peripheral edges, or only at the outer peripheral edge.

As described above, the attracting surface and/or the attracted surface are chamfered at the outer peripheral edge, so that a gap due to chamfering exists in the vicinity of the outer peripheral edge at which a magnetic force that may cause the displacement is generated. Thus, even if the attracted surface and the attracting surface contact each other, they do not contact at their outer peripheral edges, thus making it possible to suppress the occurrence of a magnetic force that may cause the displacement.

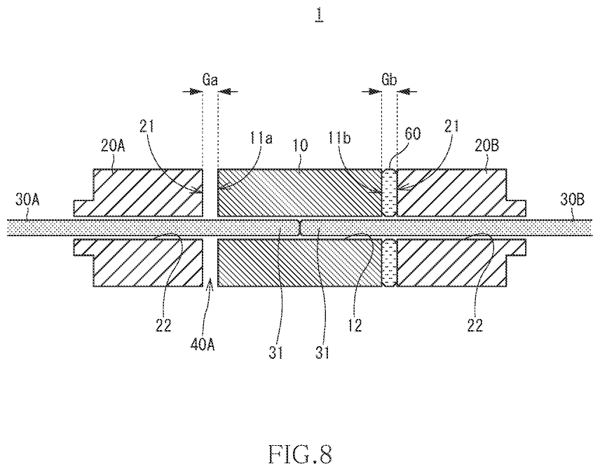

FIG. 8 is a schematic cross-sectional side view illustrating the structure of an optical fiber connector according to a fifth embodiment of the present invention.

As illustrated in FIG. 8, in the optical fiber connector 1 according to the fifth embodiment, a spacer 60 constituted by a non-magnetic body made of resin or the like is interposed between the other end surface 11b of the adaptor 10 and the front-end surface 21 of the second plug 20B. That is, the spacer 60 is provided in place of the gap 40B in the first embodiment. Other configurations are the same as those of the first embodiment.

In the present embodiment, the spacer 60 is provided only on the second plug 20B side; however, the spacer 60 may be provided only on the first plug 20A side, or may be provided both on the first plug 20A side and second plug 20B side. Further, both the spacer and gap may exist between the attracting and attracted surfaces. The spacer 60 may be formed integrally with the adaptor 10 or second plug 20B. The spacer 60 may be a coating that covers the surface of the permanent magnet or magnetic body.

According to the present embodiment, in addition to the same effects as obtained in the first embodiment, the attracted surface can forcibly be separated from the attracting surface, whereby it is possible to reliably suppress the occurrence of a magnetic force that may increase axial misalignment between the optical fiber core wires.

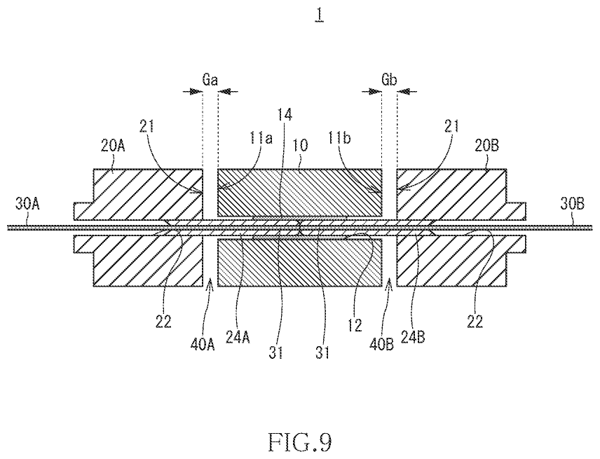

FIG. 9 is a schematic cross-sectional side view illustrating the structure of an optical fiber connector according to a sixth embodiment of the present invention.

As illustrated in FIG. 9, in the optical fiber connector 1 according to the sixth embodiment, the adaptor 10 further has a split sleeve 14, and the first and second plugs 20A and 20B have ferrules 24A and 24B, respectively. Other configurations are the same as those of the first embodiment.

The leading end portion 31 of the first optical fiber 30A is inserted into the ferrule 24A and protrudes from the front-end surface 21 of the first plug 20A together with the ferrule 24A. Thus, the first optical fiber 30A is inserted into the one insertion port 12a of the insertion hole 12 of the adaptor 10 together with the ferrule 24A and further into the split sleeve 14 inside the insertion hole 12.

Similarly, the leading end portion 31 of the second optical fiber 30B is inserted into the ferrule 24B and protrudes from the front-end surface 21 of the second plug 20B together with the ferrule 24B. Thus, the second optical fiber 30B is inserted into the other insertion port 12b of the insertion hole 12 of the adaptor 10 together with the ferrule 24B and further into the split sleeve 14 inside the insertion hole 12.

Although the optical fiber connector 1 according to the present embodiment is larger in size than the optical fiber connector 1 according to the first embodiment that does not have the split sleeve 14 or ferrules 24A and 24B, it can provide the same effects as obtained in the first embodiment. That is, the optical fiber connector 1 according to the present embodiment includes the adaptor 10 constituted by a permanent magnet and first and second plugs 20A and 20B each constituted by a magnetic body and is configured such that in a state where the end surfaces of the first and second optical fibers 30A and 30B are connected to each other in the adaptor 10, the attracted surface of each of the first and second plugs 20A and 20B does not contact the attracting surface of the adaptor 10 but is separated therefrom. This prevents the occurrence of a magnetic force that may cause axial misalignment between the optical fibers when the first and second plugs 20A and 20B are attracted and fixed to the adaptor 10 to thereby make it possible to reduce optical fiber connection loss.

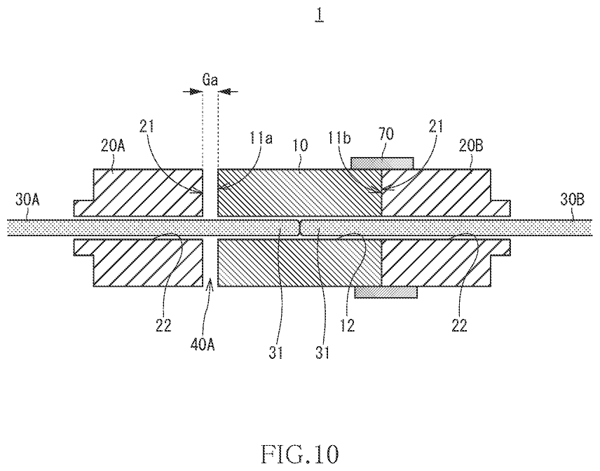

FIG. 10 is a schematic cross-sectional side view illustrating the structure of an optical fiber connector according to a seventh embodiment of the present invention.

As illustrated in FIG. 10, in the optical fiber connector 1 according to the fourth embodiment, the gap 40A is provided on the first plug 20A side, while the front-end surface 21 of the second plug 20B contacts the other end surface 11b of the adaptor 10 with no gap provided therebetween.

When the front-end surface 21 of the second plug 20B that has the same shape and size as the other end surface 11b of the adaptor 10 is attracted to contact the other end surface 11b, the second plug 20B is likely to be displaced. To cope with this, a fixing member 70 for displacement prevention is provided in the second plug 20B side. When there is little need to remove the second plug 20B from the adaptor 10, it is possible to forcibly prevent the displacement of the second plug 20B by such a countermeasure against the displacement. That is, only the first plug 20A side can have the same configuration as the first embodiment.

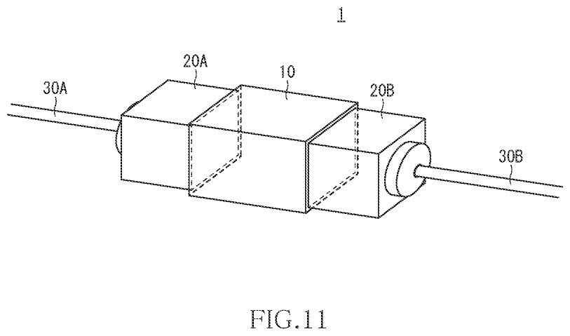

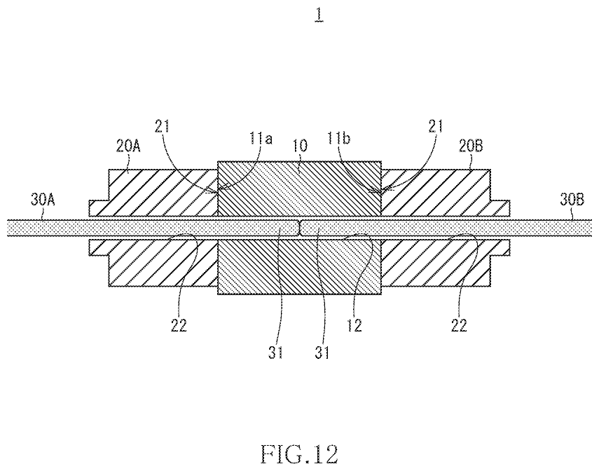

FIG. 11 is a schematic perspective view illustrating the configuration of an optical fiber connector according to an eighth embodiment of the present invention. FIG. 12 is a schematic cross-sectional side view illustrating the structure of the optical fiber connector according to the eighth embodiment.

As illustrated in FIGS. 11 and 12, in the optical fiber connector 1 according to the eighth embodiment, the front-end surface 21 (first and second attracted surfaces) of each of the first and second plugs 20A and 20B and the end surface (one and the other end surfaces 11a and 11b) of the adaptor 10 are the same in shape but different in size (outer dimension). Further, the attracted surface contacts the attracting surface with no gap provided therebetween. Other configurations are the same as those of the first embodiment.

In the present embodiment, the attracted surface is the same in shape (square) as the attracting surface but is a little smaller in size than the attracting surface. Accordingly, the outer peripheral edge of the front-end surface 21 of the first plug 20A is positioned inside and does not substantially continuously contact the outer peripheral edge of the one end surface 11a of the adaptor 10 over the entire periphery thereof. Similarly, the outer peripheral edge of the front-end surface 21 of the second plug 20B is positioned inside and does not substantially continuously contact the outer peripheral edge of the other end surface 11b of the adaptor 10 over the entire periphery thereof.

The difference between the position of the outer peripheral edge of the attracting surface and the position of the outer peripheral edge of the attracted surface is preferably 0.1 mm or more and 1.5 mm or less, and particularly preferably 0.2 mm or more and 0.5 mm or less. Thus, it is possible to obtain an effect brought about by shifting the outer peripheral edge of the attracted surface from the outer peripheral edge of the attracting surface.

The protruding amount L_{2A} of the first optical fiber 30A from the front-end surface 21 of the first plug 20A and the protruding amount L_{2B} of the second optical fiber 30A from the front-end surface 21 of the second plug 20B are each set to half the length L₁ of the adaptor 10 in the center axis direction thereof. Thus, in a state where the leading ends of the first and second optical fibers 30A and 30B are connected in the insertion hole 12 of the adaptor 10, the entire front-end surface 21 (first and second attracted surfaces) of each of the first and second plugs 20A and 20B contacts the end surface (one and the other end surfaces 11a and 11b, i.e., first and second attracting surfaces) of the adaptor 10.

When the outer peripheral edge of each of the end surfaces 11a and 11b of the adaptor 10 and the outer peripheral edge of the front-end surface 21 of each of the first and second plugs 20A and 20B almost coincide in shape with each other and substantially continuously contact each other, a magnetic force by which the edge of a magnetic body gets away from the edge of a permanent magnet exhibiting a large magnetic gradient is likely to act. This may generate a magnetic force in a direction increasing the displacement to make it likely to cause displacement in a direction perpendicular to the connector axis direction. However, when the attracted surface of each of the first and second plugs 20A and 20B is separated from the attracting surface of the adaptor 10 and does not substantially continuously contact it, the occurrence of such a magnetic force that may increase the displacement can be suppressed, thus making it possible to prevent axial misalignment between the core wires of the optical fibers.

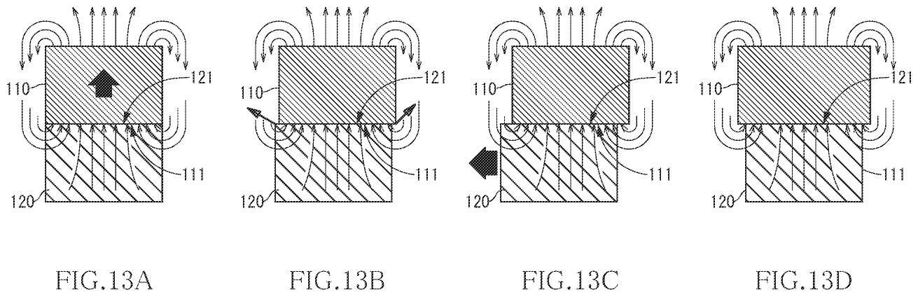

FIGS. 13A to 13D are views for explaining a magnetic force generated between a permanent magnet and a magnetic body.

As illustrated in FIG. 13A, when an attracting surface 111 of a permanent magnet 110 and an attracted surface 121 of a magnetic body 120, which coincide with each other in planar shape and size, contact each other in a completely overlapping state, magnetic symmetry is exquisitely balanced, making it possible to maintain a state where the attracting surface 111 and the attracted surface 121 completely overlap each other. However, as illustrated in FIG. 13B, when the position of the magnetic body 120 with respect to the permanent magnet 110 is displaced even slightly, a magnetic force acts in a direction increasing the displacement, resulting in increase in the displacement therebetween as illustrated in FIG. 13C.

On the other hand, as illustrated in FIG. 13D, when the attracted surface 121 of the magnetic body 120 differs in size from the attracting surface 111 of the permanent magnet 110, the edge of the permanent magnet 110 and the edge of the magnetic body 120 are separated and do not substantially continuously contact each other, so that the occurrence of a magnetic force acting in a direction increasing the displacement of the magnetic body 120 can be suppressed to thereby make it possible to prevent the magnetic body 120 from being displaced.

As described above, the optical fiber connector 1 according to the present embodiment includes the adaptor 10 constituted by a permanent magnet and first and second plugs 20A and 20B each constituted by a magnetic body and is configured such that in a state where the end surfaces of the first and second optical fibers 30A and 30B are connected to each other in the adaptor 10, the outer peripheral edge of the attracted surface of each of the first and second plugs 20A and 20B is shifted in the in-plane direction from the outer peripheral edge of the attracting surface of the adaptor 10. This prevents occurrence of a magnetic force that may cause axial misalignment between the optical fibers when the first and second plugs 20A and 20B are attracted and fixed to the adaptor 10 to thereby make it possible to reduce optical fiber connection loss.

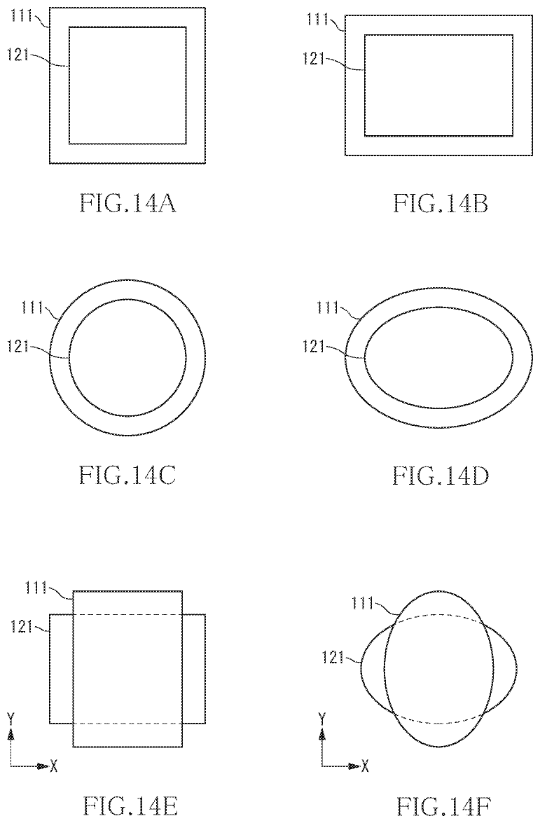

FIGS. 14A to 14F are views illustrating variations of the relation between the shape of the attracting surface of the adaptor 10 and the shape of the attracted surface of each of the first and second plugs 20A and 20B.

The shape of the attracting surface 111 of the adaptor 10 and the shape of the attracted surface 121 of each of the first and second plugs 20A and 20B illustrated in FIG. 14A are both a square. However, the outer peripheral shape of the attracted surface 121 is similar to but smaller in size than the outer peripheral shape of the attracting surface 111 and is thus positioned inside the outer peripheral edge of the attracting surface 111. When the outer peripheral edge of the attracted surface 121 is separated from the outer peripheral edge of the attracting surface 111, the occurrence of a magnetic force that may cause the displacement can be suppressed.

The shape of the attracting surface 111 of the adaptor 10 and the shape of the attracted surface 121 of each of the first and second plugs 20A and 20B illustrated in FIG. 14B are both a rectangle. However, the outer peripheral shape of the attracted surface 121 is smaller in size than the outer peripheral shape of the attracting surface 111 and is thus positioned inside the outer peripheral edge of the attracting surface 111. Thus, the outer peripheral edge of the attracted surface 121 can be separated from the outer peripheral edge of the attracting surface 111, so that the occurrence of a magnetic force that may cause the displacement can be suppressed.

The shape of the attracting surface 111 of the adaptor 10 and the shape of the attracted surface 121 of each of the first and second plugs 20A and 20B illustrated in FIG. 14C are both a circle. However, the outer peripheral shape of the attracted surface 121 is similar to but smaller in size than the outer peripheral shape of the attracting surface 111 and is thus positioned inside the outer peripheral edge of the attracting surface 111. When the outer peripheral edge of the attracted surface 121 is separated from the outer peripheral edge of the attracting surface 111, the occurrence of a magnetic force that may cause the displacement can be suppressed.

The shape of the attracting surface 111 of the adaptor 10 and the shape of the attracted surface 121 of each of the first and second plugs 20A and 20B illustrated in FIG. 14D are both an ellipse (oval). However, the outer peripheral shape of the attracted surface 121 is smaller in size than the outer peripheral shape of the attracting surface 111 and is thus positioned inside the outer peripheral edge of the attracting surface 111. Thus, the outer peripheral edge of the attracted surface 121 can be separated from the outer peripheral edge of the attracting surface 111, so that the occurrence of a magnetic force that may cause the displacement can be suppressed.

The shape of the attracting surface 111 of the adaptor 10 and the shape of the attracted surface 121 of each of the first and second plugs 20A and 20B illustrated in FIG. 14E are both a rectangle. Before the attracted surface 121 and the attracting surface 111 are combined, they are the same in shape and size (congruent). However, when the attracted surface 121 is shifted by 90° with respect to the attracting surface 111, the outer peripheral edge of the attracted surface 121 can be shifted from the outer peripheral edge of the attracting surface 111.

When the long side of the attracted surface 121 is made orthogonal to the long side of the attracting surface 111, the outer peripheral edge of the attracting surface 111 that is parallel to the Y-direction is positioned inside the outer peripheral edge of the attracted surface 121 that is parallel to the Y-direction since the outer dimension of the attracted surface 121 in the X-direction is larger than that of the attracting surface 111. Conversely, since the outer dimension of the attracted surface 121 in the Y-direction is smaller than that of the attracting surface 111, the outer peripheral edge of the attracting surface 111 that is parallel to the X-direction is positioned outside the outer peripheral edge of the attracted surface 121 that is parallel to the X-direction.

The outer peripheral edge of the attracted surface 121 crosses the outer peripheral edge of the attracting surface 111 at four points. Although the outer peripheral edges make a point-contact at the respective intersections, they do not continuously contact along the X- or Y-direction, so that a magnetic force that may cause axial misalignment between the optical fibers does not occur. Although the position of the outer peripheral edge of the attracted surface 121 viewed from the outer peripheral edge of the attracting surface 111 differs depending on the position in the peripheral direction as described above, the outer peripheral edge of the attracted surface 121 is separated from the outer peripheral edge of the attracting surface 111 over the entire periphery. This prevents occurrence of a magnetic force that may cause axial misalignment between the optical fibers to thereby make it possible to reduce optical fiber connection loss.

The shape of the attracting surface 111 of the adaptor 10 and the shape of the attracted surface 121 of each of the first and second plugs 20A and 20B illustrated in FIG. 14F are both an ellipse (oval). Before the attracted surface 121 and the attracting surface 111 are combined, they are the same in shape and size (congruent). However, like the relation between the attracting surface 111 and the attracted surface 121 illustrated in FIG. 14E, when the attracted surface 121 is shifted by 90° with respect to the attracting surface 111, the outer peripheral edge of the attracted surface 121 can be shifted from the outer peripheral edge of the attracting surface 111. This prevents the occurrence of a magnetic force that may cause axial misalignment between the optical fibers to thereby make it possible to reduce optical fiber connection loss.

As described above, even though the attracting surface 111 and the attracted surface 121 are the same in shape and size before they are combined, the outer peripheral edge of the attracted surface 121 can be shifted from the outer peripheral edge of the attracting surface 111 when the attracting surface 111 and attracted surface 121 have a shape elongated in one direction. The outer peripheral edge of the attracting surface 111 in the vertical direction crosses and contacts at one point the outer peripheral edge of the attracted surface 121 in the horizontal direction but does not continuously (linearly) contact it, thus making it possible to prevent the occurrence of a magnetic force that may cause axial misalignment between the optical fibers.

Although all the variations illustrated in FIGS. 14A to 14F are cases where the outer peripheral edge of the attracted surface 121 is positioned inside the outer peripheral edge of the attracting surface 111, the outer peripheral edge of the attracted surface 121 may be positioned outside the outer peripheral edge of the attracting surface 111. The area ratio of the attracted surface 121 to the attracting surface 111 is preferably 0.18 or more and 4.29 or less. When the area of the attracted surface 121 is extremely different from the area of the attracting surface 111, an attractive force therebetween becomes insufficient, and a magnetic force in a direction correcting the displacement cannot be generated.

In the present embodiment, the one end surface 11a (first attracting surface) of the adaptor 10 and the other end surface 11b (second attracting surface) are the same in shape and size. However, the one end surface 11a may have a different shape from the other end surface 11b. For example, the one and the other end surfaces 11a and 11b may be formed into a square and a rectangle, respectively. Alternatively, both the one and the other end surfaces 11a and 11b may be formed into a circle with the diameter of the one end surface 11a set larger than the diameter of the other end surface 11b. In this case, the first and second plugs 20A and 20B are preferably made different in shape in accordance with the difference in shape between the one and the other end surfaces 11a and 11b of the adaptor 10.

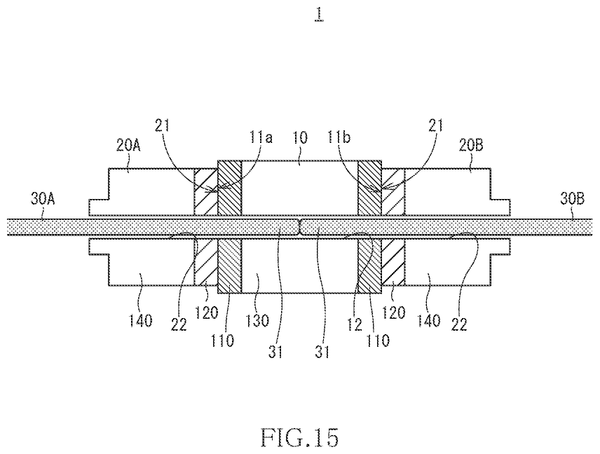

FIG. 15 is a cross-sectional side view of an optical fiber connector according to a ninth embodiment of the present invention, which illustrates a modification of the adaptor 10.

As illustrated in FIG. 15, in the optical fiber connector 1 according to the present embodiment, only both end portions of the adaptor 10 including the one and the other end surfaces 11a and 11b are constituted by the permanent magnet 110, while a center portion 130 thereof is constituted by a non-magnetic body. Further, in each of the first and second plugs 20A and 20B, only the front portion including the front-end surface 21 is constituted by the magnetic body 120, while the rear portion is constituted by a non-magnetic body 140. Other configurations are the same as those of the eighth embodiment.

A material of the non-magnetic body constituting the center portion 130 of the adaptor 10 and a material of the non-magnetic body 140 constituting the rear portions of the respective first and second plugs 20A and 20B may be the same or different and is non-magnetic metal, resin, ceramic, or the like. Thus, the adaptor 10 may be constituted only partially by the permanent magnet 110, and the first and second plugs 20A and 20B may each be constituted only partially by the magnetic body 120. According to the present embodiment, it is possible to achieve reduction in weight and cost of the adaptor 10 and first and second plugs 20A and 20B in addition to the same effects as obtained in the first embodiment.

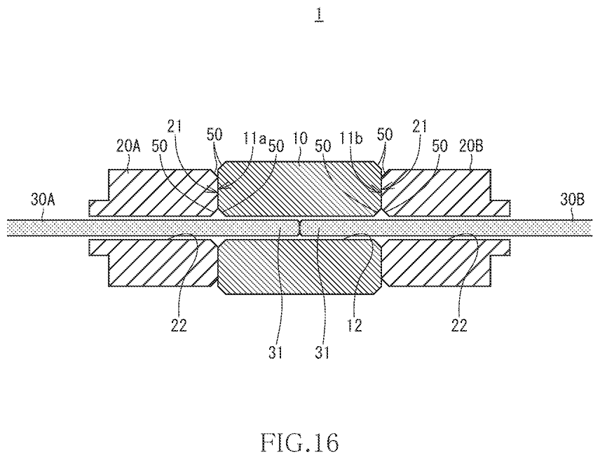

FIG. 16 is a schematic cross-sectional side view illustrating the structure of an optical fiber connector according to a tenth embodiment of the present invention.

As illustrated in FIG. 16, in the optical fiber connector 1 according to the present embodiment, the outer and inner peripheral edges of each of the one and the other end surfaces 11a and 11b of the adaptor 10 are chamfered. Further, the outer and inner peripheral edges of the front-end surface 21 of each of the first and second plugs 20A and 20B are also chamfered. A chamfered portion 50 is not particularly limited in shape and may be a curved surface (R-surface) or a 45-degree flat surface (C-surface). Other configurations are the same as those of the eighth embodiment.

When the profile of the attracting surface of the permanent magnet and the profile of the attracted surface of the magnetic body coincide with each other as described above, a magnetic force by which the edge of a magnetic body gets away from the edge of the permanent magnet with a large magnetic gradient is likely to act. This may generate a magnetic force in a direction increasing the displacement to make it likely to cause displacement in a direction perpendicular to the connector axis direction. However, when the outer dimensions of the attracting and attracted surfaces are different, and further, the outer and inner peripheral edges of each of the attracting and attracted surfaces are chamfered, the occurrence of such a magnetic force that may increase the displacement can be suppressed, thus making it possible to prevent axial misalignment between the core wires of the optical fibers.

When the outer dimensions of the attracting and attracted surfaces are different, and further, the outer and inner peripheral edges of the attracting surface or attracted surface are chamfered, the occurrence of a magnetic force that may cause axial misalignment between the first and second plugs 20A and 20B can be suppressed, so that the gap may not necessarily be provided between the attracting and attracted surfaces, and the attracted surface may be attracted to contact the attracting surface. Even if the attracted surface and the attracting surface contact each other, the occurrence of a magnetic force that may cause the displacement can be suppressed since the gap exists in the vicinity of the outer peripheral edge at which a magnetic force that may cause the displacement is generated.

In the present embodiment, the chamfered portion 50 is formed at each of the one and the other end surfaces 11a and 11b of the adaptor 10 and at the front-end surface 21 of each of the first and second plugs 20A and 20B; however, the chamfered portion 50 may be formed only in the first and second plugs 20A and 20B with the chamfered shape of the adaptor 10 omitted. Conversely, the chamfered portion 50 may be formed only in the adaptor 10 with the chamfered shape of each of the first and second plugs 20A and 20B omitted. Further, as illustrated, the attracting surface of the adaptor 10 and the attracted surface of each of the first and second plugs 20A and 20B may be chamfered at both the outer and inner peripheral edges, only at the outer peripheral edge, or only at the inner peripheral edge.

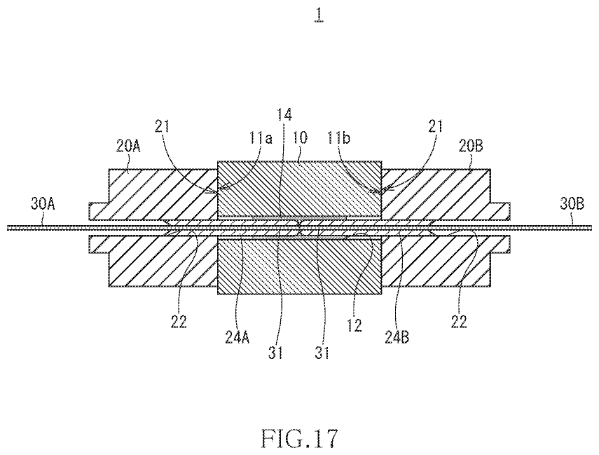

FIG. 17 is a schematic cross-sectional side view illustrating the structure of an optical fiber connector according to an eleventh embodiment of the present invention.

As illustrated in FIG. 17, in the optical fiber connector 1 according to the eleventh embodiment, the adaptor 10 further has a split sleeve 14, and the first and second plugs 20A and 20B have ferrules 24A and 24B, respectively. Other configurations are the same as those of the eighth embodiment.

The leading end portion 31 of the first optical fiber 30A is inserted into the ferrule 24A and protrudes from the front-end surface 21 of the first plug 20A together with the ferrule 24A. Thus, the first optical fiber 30A is inserted into the one insertion port 12a of the insertion hole 12 of the adaptor 10 together with the ferrule 24A and further into the split sleeve 14 inside the insertion hole 12.

Similarly, the leading end portion 31 of the second optical fiber 30B is inserted into the ferrule 24B and protrudes from the front-end surface 21 of the second plug 20B together with the ferrule 24B. Thus, the second optical fiber 30B is inserted into the one insertion port 12b of the insertion hole 12 of the adaptor 10 together with the ferrule 24B and further into the split sleeve 14 inside the insertion hole 12.

Although the optical fiber connector 1 according to the present embodiment is larger in size than the optical fiber connector 1 according to the eighth embodiment that does not have the split sleeve 14 or ferrules 24A and 24B, it can provide the same effects as obtained in the eighth embodiment. That is, the optical fiber connector 1 according to the present embodiment includes the adaptor 10 constituted by a permanent magnet and the first and second plugs 20A and 20B constituted by a magnetic body and is configured such that in a state where the end surfaces of the first and second optical fibers 30A and 30B are connected to each other in the adaptor 10, the attracted surface of each of the first and second plugs 20A and 20B does not contact the attracting surface of the adaptor 10 but is separated therefrom. This prevents the occurrence of a magnetic force that may cause axial misalignment between the optical fibers when the first and second plugs 20A and 20B are attracted and fixed to the adaptor 10 to thereby make it possible to reduce optical fiber connection loss.

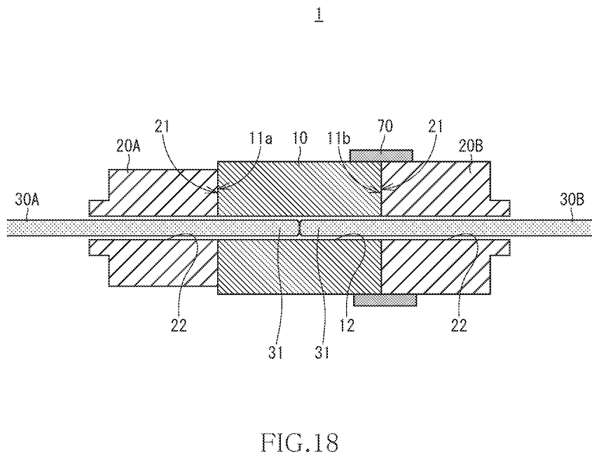

FIG. 18 is a schematic cross-sectional side view illustrating the structure of an optical fiber connector according to a twelfth embodiment of the present invention.

As illustrated in FIG. 18, in the optical fiber connector 1 according to the twelfth embodiment, only the front-end surface 21 (attracted surface) of the first plug 20A is a little smaller in size than the one end surface 11a (attracting surface) of the adaptor 10, while the front-end surface 21 (attracted surface) of the second plug 20B is the same in shape and size as the other end surface 11b of the adaptor 10.

When the front-end surface 21 of the second plug 20B that has the same shape and size as the other end surface 11b of the adaptor 10 is attracted to the other end surface 11b, the second plug 20B is likely to be displaced. To cope with this, a fixing member 70 for displacement prevention is provided in the second plug 20B side in the present embodiment. When there is almost no occasion to remove the second plug 20B from the adaptor 10, it is possible to forcibly prevent the displacement of the second plug 20B by such a countermeasure against the displacement. That is, only the first plug 20A side can have the same configuration as the eighth embodiment.

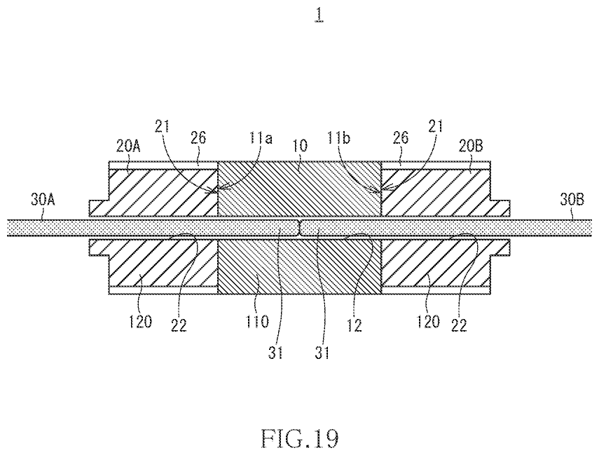

FIG. 19 is a schematic cross-sectional side view illustrating the structure of an optical fiber connector according to a thirteenth embodiment of the present invention.

As illustrated in FIG. 19, in the optical fiber connector 1 according to the thirteenth embodiment, the outer dimension of the magnetic body 120 of each of the first and second plugs 20A and 20B is smaller in size than the outer dimension of the permanent magnet 110 of the adaptor 10, but the outer dimension of each of the first and second plugs 20A and 20B and the outer dimension of the adaptor 10 are made equal in size by using a non-magnetic cover 26 that covers the periphery of the magnetic body 120. Other configurations are the same as those of the eighth embodiment. According to the present embodiment, the outer peripheral surface of the adaptor 10 and the outer peripheral surface of each of the first and second plugs 20A and 20B can be made flush with each other, whereby it is possible to confirm in a visual or tactile manner that each of the first and second plugs 20A and 20B is adjusted in position with respect to the adaptor 10.

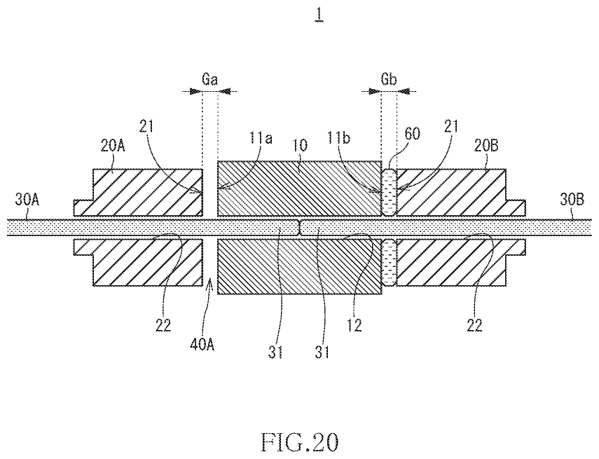

FIG. 20 is a schematic cross-sectional view illustrating the structure of an optical fiber connector according to a fourteenth embodiment of the present invention.

As illustrated in FIG. 20, in the optical fiber connector 1 according to the fourteenth embodiment, the attracted surface of each of the first and second plugs 20A and 20B is attracted and fixed to the adaptor 10 in a state where it is not in contact with but separated from the attracting surface of the adaptor 10. Specifically, the gap 40A is provided between the attracting and attracted surfaces on the first plug 20A side, while the spacer 60 is interposed between the attracting and attracted surfaces on the second plug 20B side. Other configurations are the same as those of the eighth embodiment.

In the present embodiment, the protruding amount L_{2A} of the first optical fiber 30A from the first plug 20A and the protruding amount L_{2B} of the second optical fiber 30B from the second plug 20B are each larger than half the length L₁ of the adaptor 10 (L_{2A}>L₁/2, L_{2B}>L₁/2, see FIG. 3). Thus, as illustrated in FIG. 20, in a state where the first and second optical fibers 30A and 30B are inserted into the insertion hole of the adaptor 10 and connected to each other at their leading ends, the front-end surface 21 of the first plug 20A does not contact the one end surface 11a of the adaptor 10 with the slight gap 40A interposed therebetween. Further, the spacer 60 is interposed between the front-end surface 21 of the second plug 20B and the other end surface 11b of the adaptor 10. However, a magnetic force is exerted between the adaptor 10 and the first and second plugs 20A and 20B, and thus the front-end surfaces 21 of the first and second plugs 20A and 20B are attracted to the adaptor 10 side, thereby achieving a reliable connection between the leading end portions 31 of the first and second optical fibers 30A and 30B.

The space between the front-end surface 21 of the first plug 20A and one end surface 11a of the adaptor 10 and the space between the front-end surface 21 of the second plug 20B and the other end surface 11b of the adaptor 10 serve to prevent displacement of the first and second plugs 20A and 20B. When the outer peripheral edge of the front-end surface 21 of each of the first and second plugs 20A and 20B is close to the outer peripheral edge of each of the end surfaces 11a and 11b of the adaptor 10, a repulsion force by which the edge of a magnetic body gets away from the edge of a permanent magnet exhibiting a large magnetic gradient is likely to act. This may generate a magnetic force in a direction increasing the displacement to make it likely to cause displacement in a direction perpendicular to the connector axis direction. However, when the attracted surface of each of the first and second plugs 20A and 20B is separated from the attracting surface of the adaptor 10, the occurrence of such a magnetic force that may increase the displacement can be suppressed, thus making it possible to prevent axial misalignment between the core wires of the optical fibers.

A width Ga of the gap between the front-end surface 21 of the first plug 20A and the one end surface 11a of the adaptor 10 and a width Gb of the gap between the front-end surface 21 of the second plug 20B and the other end surface 11b of the adaptor 10 are each preferably 0.5 μm or more and 240 μm or less and more preferably 10 μm or more and 240 μm or less. When the widths Ga and Gb between the attracting and attracted surfaces are each 0.5 μm or more, it is possible to suppress displacement of the first and second plugs 20A and 20B with respect to the adaptor 10. Further, when the widths Ga and Gb between the attracting and attracted surfaces are each 10 μm or more, it is possible to absorb mounting error of the first and second optical fibers 30A and 30B with respect to the first and second plugs 20A and 20B and further to reliably contact the end surfaces of the first and second optical fibers 30A and 30B. Furthermore, when the widths Ga and Gb between the attracting and attracted surfaces are each 240 μm or less, it is possible to apply a sufficient attractive force to the first and second optical fibers 30A and 30B.

The permanent magnet constituting the adaptor 10 preferably applies a pressing force of 1N or more to the first and second optical fibers 30A and 30B integrated with the respective first and second plugs 20A and 20B. By applying a pressing force of 1N or more to the first and second optical fibers 30A and 30B, the end surfaces of the first and second optical fibers 30A and 30B are elastically deformed to be tightly fitted to each other, thus achieving a reliable connection between the end surfaces of the optical fiber core wires.

To apply a pressing force of 1N or more to the first and second optical fibers 30A and 30B, it is preferable to set the ratio G/S of the width G of the gap to the area S of the attracting surface of the adaptor 10 constituted by a permanent magnet to 0.08 or more and 38 or less (0.08 [1/m]≤G/S≤38 [1/m]). When the G/S is 0.08 [1/m] or more, the occurrence of a magnetic force that may increase the displacement with respect to the adaptor 10 can be suppressed, whereby it is possible to suppress axial misalignment between the optical fiber core wires to reduce optical fiber connection loss. Further, when the G/S is 38 [1/m] or less, it is possible to ensure a magnetic force required to apply a pressing force for PC connection, thereby making it possible to prevent decrease in optical fiber connection loss.

In the present embodiment, the spacer 60 is provided only on the second plug 20B side; however, the spacer 60 may be provided only on the first plug 20A side, or may be provided both on the first plug 20A side and second plug 20B side. Further, both the spacer 60 and a gap may exist between the attracting and attracted surfaces. The spacer 60 may be formed integrally with the adaptor 10 or second plug 20B. The spacer 60 may be a coating that covers the surface of the permanent magnet or magnetic body. As described above, various combinations may be possible in the present embodiment.

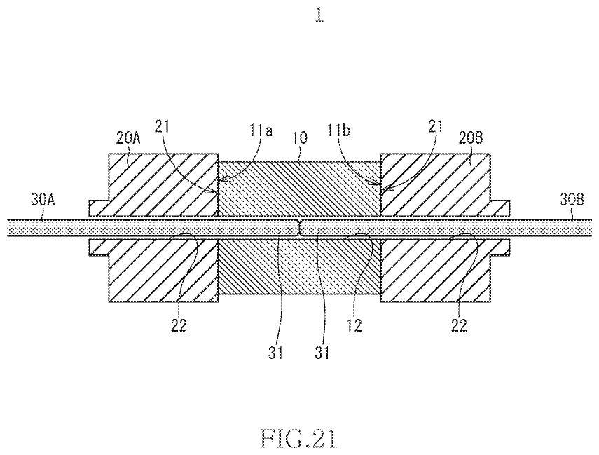

FIG. 21 is a schematic cross-sectional view illustrating the structure of an optical fiber connector according to a fifteenth embodiment of the present invention.

As illustrated in FIG. 21, in the optical fiber connector 1 according to the fifteenth embodiment, the size of the front-end surface 21 (first and second attracted surfaces) of each of the first and second plugs 20A and 20B is slightly smaller than the size of each of their corresponding one and the other end surfaces 11a and 11b (first and second attracting surfaces) of the adaptor 10. Accordingly, the outer peripheral edge of the front-end surface 21 of the first plug 20A is positioned outside the outer peripheral edge of the one end surface 11a of the adaptor 10 over the entire periphery. Similarly, the outer peripheral edge of the front-end surface 21 of the second plug 20B is positioned outside the outer peripheral edge of the other end surface 11b of the adaptor 10 over the entire periphery. Other configurations are the same as those of the eighth embodiment.

According to the present embodiment, in addition to the same effects as obtained in the eighth embodiment, a magnetic force in a direction reducing the displacement can be increased. Therefore, for example, although there may be a case where the position of the first plug 20A with respect to the adaptor 10 is slightly displaced due to application of some external force, a repulsion force occurs between a part of the outer peripheral edge of the attracted surface and a part of the outer peripheral edge of the attracting surface when they approach each other, causing a magnetic force that sets back the center of the first plug 20A to the center of the adaptor 10 to act. Thus, the displacement of the first plug 20A can be corrected automatically.

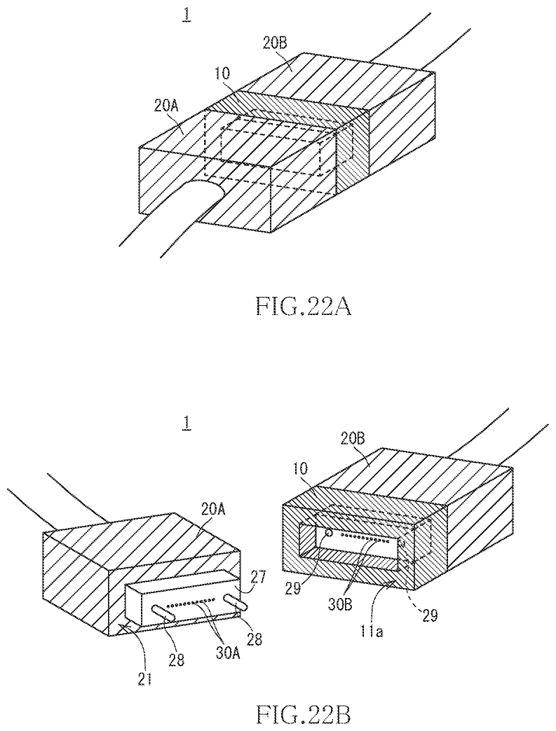

FIGS. 22A and 22B are schematic perspective views illustrating the structure of an optical fiber connector according to a sixteenth embodiment of the present invention. FIG. 22A illustrates a state where the first and second plugs 20A and 20B are connected to the adaptor 10, and FIG. 22B illustrates a state where the first plug 20A is removed from the adaptor 10.

As illustrated in FIGS. 22A and 22B, the optical fiber connector 1 according to the sixteenth embodiment is of so-called multicore type. Specifically, a plurality of (twelve, in this example) optical fibers 30A and a plurality of (twelve, in this example) optical fibers 30B are connected together. The optical fibers 30A are mounted to the first plug 20A through a support member 27, and the optical fibers 30B are mounted to the second plug 20B through a support member 27. To increase connection operability and reliability, a guide pin 28 is provided on the first plug 20A side and, correspondingly, a guide pin insertion hole 29 is provided on the second plug 20B side. When connecting the first and second plugs 20A and 20B through the adaptor 10, the guide pin 28 is inserted into the guide pin insertion hole 29. Other configurations are the same as those of any one of the above-described first through fifteenth embodiments of the present invention. The above embodiments of the present invention can be applied to an optical fiber connector of multicore type. The multicore type includes, for example, those for 4, 8, 12, 16 fibers.

While the preferred embodiments of the present invention have been described above, the present invention is not limited to the above embodiments, and various modifications may be made within the scope of the present invention, and all such modifications are included in the present invention.

For example, in the above embodiments, the adaptor 10 is constituted by a permanent magnet, and the first and second plugs 20A and 20B are each constituted by a magnetic body to generate an attractive force by a magnetic force; conversely, the adaptor 10 may be constituted by a magnetic body, and the first and second plugs 20A and 20B may each be constituted by a permanent magnet. Further, the above-described embodiments can be combined appropriately.

### EXAMPLES

The influence of the width of the gap between the attracting surface of the adaptor 10 and the attracted surface of each of the first and second plugs 20A and 20B exerted on optical fiber connection loss was evaluated. It is estimated as follows: when no gap is present between the attracting and attracted surfaces, the connection loss increases due to the influence of a magnetic force in a direction that may cause the displacement; and when the gap therebetween is extremely large, the connection loss increases due to reduction in strength of a magnetic force that presses optical fiber end surfaces against each other.

The connection loss was calculated by using a finite element method analysis on a computer. Specifically, a magnetic force between the adaptor and the plug was calculated using software “ANSYS Maxwell” supplied by ANSYS Inc. and software “JMAG” supplied by JSOL Corporation, and the degree of deformation of the split sleeve was calculated using the structural analysis function of CAD “SolidWorks” supplied by Dassault Systémes SolidWorks Corporation. Thereafter, the connection loss was calculated from the amount of deformation according to the following relational expression (wherein L: connection loss [dB], d: deformation amount (displacement), and D: mode field diameter).

L=10 log {exp(d²/D²)}

The following describes an analysis method using the finite element method. In calculation of a magnetic force between the adaptor and the plug, neodymium magnet NEOREC 50BF manufactured by TDK Corporation was used as the adaptor, which had a structure obtained by drilling a hole with a diameter of 1.85 mm in the height direction in a rectangular parallelepiped of 3 mm (vertical width)×3 mm (horizontal width)×3.2 mm (height), and SUS430 was used as the plug, which had a structure obtained by drilling a hole with a diameter of 1.25 mm in the height direction in a cube of 3 mm×3 mm×3 mm. The holes of the plug and adaptor were concentrically arranged on the same axis. A contact state between the plug and the adaptor was defined as an origin. In the above configuration, a magnetic force upon displacement of the plug in a direction perpendicular to the axis from the origin was calculated.

In the calculation of the deformation amount of the split sleeve, the split sleeve was assumed to be one for a conventional LC connector, which was made of zirconia and had an outer diameter of about 1.6 mm, an inner diameter of about 1.25 mm, and a length of 2 mm (only the length was subjected to a restriction of the length of the adaptor). The magnetic force obtained through the above calculation was applied in a direction to expand the split line of the split sleeve, and the deformation amount of the split sleeve was calculated. The structure in the example included a combination of a first plug, an adaptor, and a second plug, and thus a magnetic force would occur at two boundary portions, so that the magnetic force to be applied was obtained by doubling the calculation result thereof.

Prior to the calculation of the connection loss, the influence of the width of a gap between the attracting surface of the adaptor 10 and the attracted surface of the first plug 20A exerted on axial misalignment was evaluated. Specifically, the attracted surface of the first plug 20A of the optical fiber connector 1 was made to face one attracting surface of the adaptor 10 with the gap interposed therebetween, and then the adaptor 10 was displaced in a direction (X-direction) parallel to the attracting surface. In this state, the direction and magnitude of a displacement force acting on the adaptor 10 were calculated. The width of the gap was set to 10 sizes: 0 μm (no gap), 0.2 μm, 0.5 μm, 1 μm, 10 μm, 20 μm, 40 μm, 100 μm, 200 μm, and 300 μm. The outer peripheral edges of the respective attracting and attracted surfaces were not chamfered.

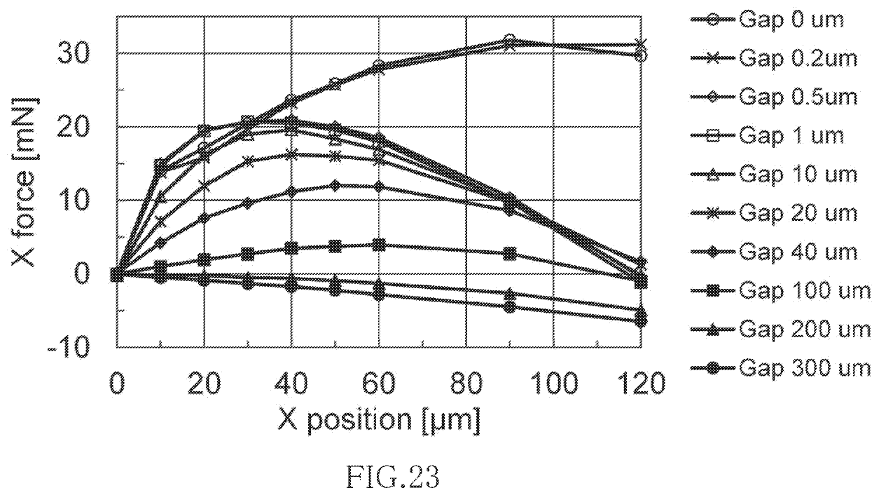

FIG. 23 is a graph illustrating the relation between a displacement amount and a displacement force, in which the horizontal axis represents a displacement amount [μm], and the vertical axis represents a displacement force [mN] in the X-direction acting on the adaptor 10.

As illustrated in FIG. 23, with the gap width of 0 μm (no gap) or 0.2 μm, a large force in the positive X-direction, i.e., a large force causing the adaptor 10 to be away from the reference point acted even though the adaptor 10 was displaced in the X-direction by 120 μm or more. With the gap width of 0.5 μm or more, the force in the positive X-direction became weak and, in particular, when the adaptor 10 was displaced in the X-direction by 40 μm or more, the force in the positive X-direction became weaker. With the gap width of 200 μm or more, a force acted in the negative X-direction. Further, with the gap width of 0.5 μm, the local maximum value of the displacement force in the X-direction was 22 mN in the displacement range of the adaptor 10 from 0 μm to 120 μm in the x-direction, and with the gap width of 0.5 μm or more, the local maximum value of the displacement force in the X-direction was less than 22 mN.

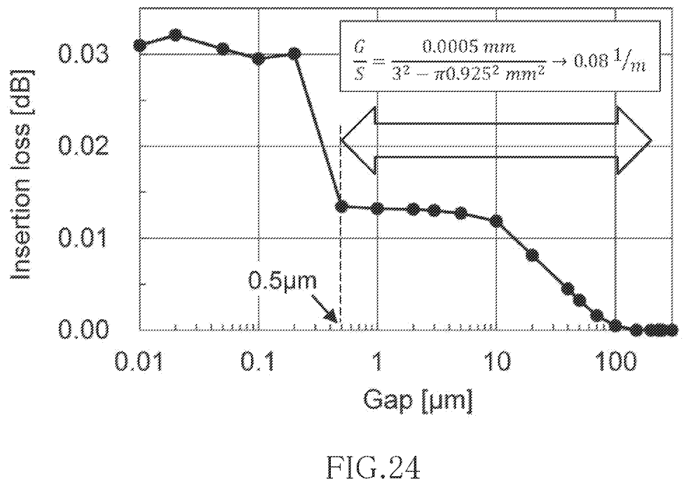

FIG. 24 is a graph illustrating the relation between the width of the gap between the attracting and attracted surfaces and the connection loss of the optical fiber that can be caused by a magnetic force.

As illustrated in FIG. 24, when the width G of the gap was 0.2 μm or less (G/S≤0.03 [1/m]), the connection loss assumed a relatively large value around 0.03 dB, while when the width G of the gap was 0.5 μm or more (G/S≥0.08 [1/m]), the connection loss was reduced to 0.015 dB or less. Further, when the width G of the gap was 20 μm or more (G/S≥3.17 [1/m]), the connection loss was reduced to 0.01 dB or less, and when the width G of the gap was 100 μm or more (G/S≥15.8 [1/m]), the connection loss became substantially 0 dB. As described above, when the attracted and attracting surfaces were in close proximity with each other, axial misalignment between the optical fibers occurred due to the influence of a magnetic force in a direction increasing the displacement, resulting in an increase in connection loss. However, the influence of a magnetic force causing the displacement became less as the attracted surface separated further away from the attracting surface. Thus, it was found that the connection loss was sufficiently reduced to 0.15 dB or less in the range of the gap width with which a displacement force in the x-direction became smaller than the local maximum value of 22 mN shown in FIG. 23.

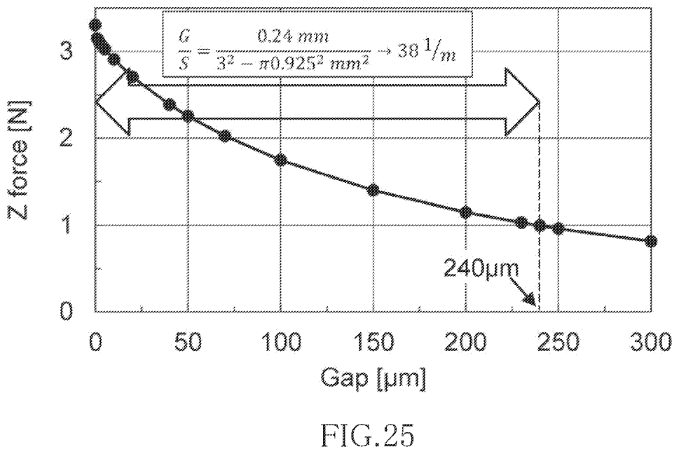

FIG. 25 is a graph illustrating the width of the gap between the attracting and attracted surfaces and a pressing force Z_{force} generated by a magnetic force.

As illustrated in FIG. 25, the pressing force Z_{force} in the center axis direction (Z-axis direction) lowered as the width G of the gap was increased. A pressing force against the optical fiber was preferably 1N or more. When the width G of the gap was 240 μm or less (G/S≤38 [1/m]), such a pressing force was able to be applied; however, when the width G of the gap was more than 240 μm (G/S>38 [1/m]), a pressing force of 1N or more was unable to be applied. In the present embodiment, an attracting force that a permanent magnet applied to a magnetic body became stronger as the area S of the attracting surface was larger. Thus, when the area S of the attracting surface is large, a pressing force of 1N or more is able to be applied even with a large width G of the gap between the attracting and attractive surfaces.

Then, the influence that a C-chamfering width of the outer peripheral edge of each of the attracting surface of the adaptor 10 and the attracted surface of the first plug 20A had on axial misalignment was evaluated by simulation. The chamfering width was set to eight sizes: 0 μm (not chamfered), 0.1 μm, 1 μm, 10 μm, 50 μm, 100 μm, 400 μm, and 800 μm. No gap was provided between the attracting and attracted surfaces.

Then, the first plug 20A of the optical fiber connector 1 was attracted to the one end surface 11a of the adaptor 10, and then the adaptor 10 was displaced in a direction (X-direction) parallel to the attracting surface. In this state, the direction and magnitude of a displacement force acting on the adaptor 10 were evaluated by simulation (magnetic field analysis).

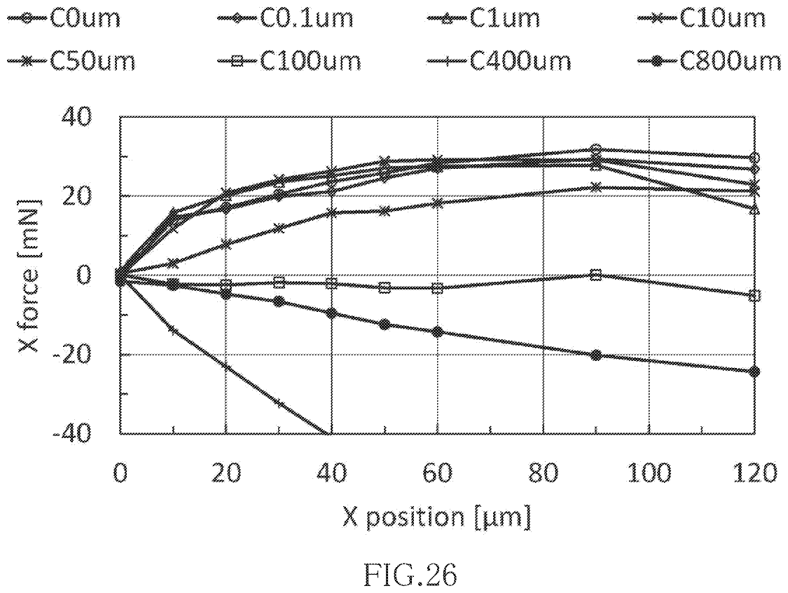

FIG. 26 is a graph illustrating the relation between a displacement amount and a displacement force, in which the horizontal axis represents a displacement amount [μm], and the vertical axis represents a displacement force [mN] in the X-direction acting on the adaptor 10.

As illustrated in FIG. 26, when the chamfering width was 0 μm (not chamfered) or 0.1 μm, a force in the positive X-direction, i.e., a force causing the adaptor 10 to be away from the reference point acted. On the other hand, when the chamfering width was 1 μm or more, a force in the negative X-direction, i.e., a force causing the adaptor 10 to approach the reference point acted, and the force in the negative X-direction increased as the chamfering width increased.

Then, the influence of the chamfering width exerted on the connection loss of the optical fiber was evaluated (magnetic field analysis and structural analysis).

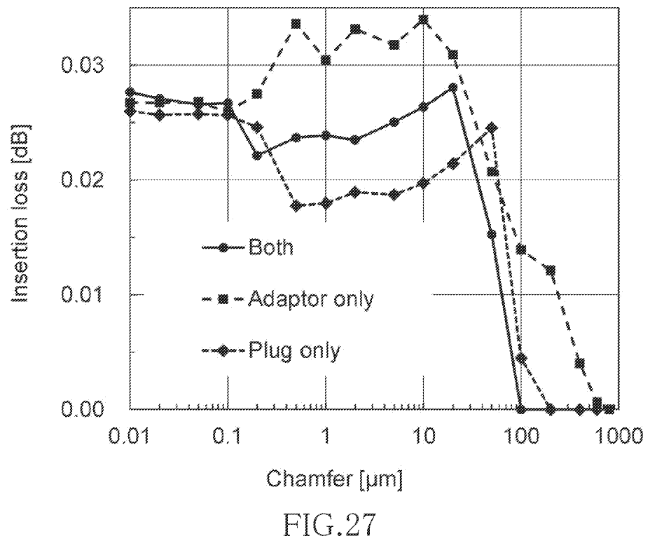

FIG. 27 is a graph illustrating evaluation results of the influence of the chamfering width on the connection loss of the optical fiber, in which the horizontal axis represents chamfering width [μm], and the vertical axis represents connection loss [dB].

As illustrated in FIG. 27, a reduction effect of the connection loss by the chamfering appeared when the chamfering width was 10 μm or more. In particular, in a configuration where the chamfering was made for both the attracting and attracted surfaces, the connection loss reduction effect was obtained when the chamfering width was 20 μm or more, and the connection loss became zero when the chamfering width was 100 μm or more. Further, in a configuration where the chamfering was made for only the adaptor, the connection loss reduction effect was obtained when the chamfering width was 20 μm or more, and the connection loss became zero when the chamfering width was 800 μm or more. In a configuration where the chamfering was made for only the first plug, the connection loss reduction effect was obtained when the chamfering width was 50 μm or more, and the connection loss became zero when the chamfering width was 200 μm or more.

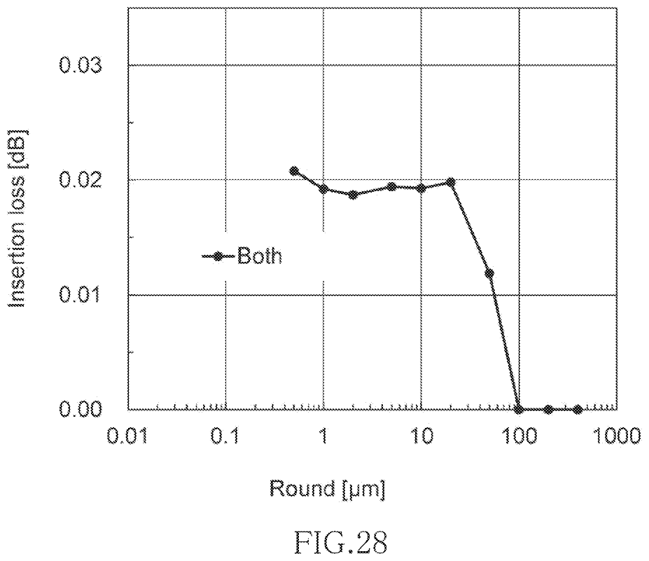

R-chamfering was evaluated in the same manner as the above-described evaluation for the C-chamfering. As a result, as illustrated in FIG. 28, in a configuration where R-chamfering was made for both the attracting and attracted surfaces, the connection loss reduction effect was obtained when the chamfering width was 20 μm or more, and the connection loss became zero when the chamfering width was 100 μm or more.

Then, the influence of the chamfering width exerted on a pressing force against the optical fiber was evaluated by simulation (magnetic field analysis).

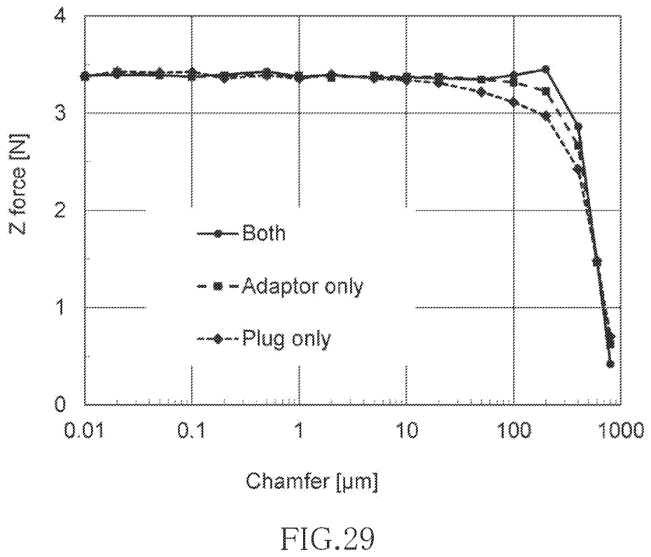

FIG. 29 is a graph illustrating evaluation results of the influence of the chamfering width exerted on a pressing force against the optical fiber, in which the horizontal axis represents chamfering width [μm], and the vertical axis represents a force [N] in the Z-direction acting on the adaptor 10.

As illustrated in FIG. 29, the pressing force was roughly constant until the chamfering width was 200 μm; however, the pressing force lowered when the chamfering width was 400 μm or more. It was found from the result that the chamfering width was preferably set to 400 μm or less and that an excessively large chamfering width disadvantageously reduced the pressing force due to a reduction in the area of the attracting surface.

### Examples 1-1, 1-2, 1-3 and Comparative Examples 1-1, 1-2, 1-3: Cases Where Connection Surface is Square

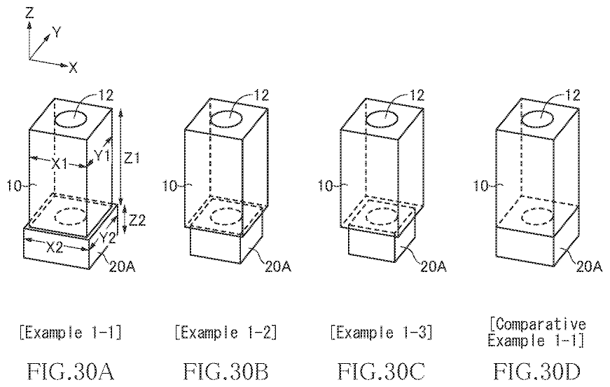

The displacement force of the optical fiber connector 1 having a square connection surface was evaluated. As illustrated in FIGS. 30A to 30D, the outer dimension (vertical width Y1×horizontal width X1×length Z1) of the adaptor 10 of the optical fiber connector 1 was common in Examples 1-1, 1-2, 1-3 and Comparative Example 1 and was 3.0 mm×3.0 mm×5.0 mm. The diameter of the insertion hole 12 for the optical fiber was ϕ1.5 mm.

As illustrated in FIG. 30A, the first plug 20A of the optical fiber connector 1 in Example 1-1 had an outer dimension (vertical width Y2×horizontal width X2×length Z2) of 3.4 mm×3.4 mm×1.5 mm. The attracted surface of the first plug 20A had a square shape like the attracting surface of the adaptor 10 and was slightly larger in area than the attracting surface, so that an exposed area having a width of 0.2 mm was presented at the outer periphery of the attracted surface.

As illustrated in FIG. 30B, the first plug 20A of the optical fiber connector 1 in Example 1-2 had an outer dimension of 2.6 mm×2.6 mm×1.5 mm, and the attracted surface thereof had an area slightly smaller than the attracting surface of the adaptor 10. Further, as illustrated in FIG. 30C, the first plug 20A of the optical fiber connector 1 in Example 1-3 had an outer dimension of 2.4 mm×2.4 mm×1.5 mm, and the attracted surface thereof had an area smaller than the outer dimension of the first plug 20A in Example 1-2. In Examples 1-2 and 1-3, an exposed area with a constant width was presented at the outer periphery of not the attracted surface but the attracting surface.

On the other hand, as illustrated in FIG. 30D, the first plug 20A of the optical fiber connector 1 in Comparative Example 1-1 had an outer dimension (vertical width Y1×horizontal width X1×length Z1) of 3.0 mm×3.0 mm×1.5 mm, and the shape and size of the attracted surface thereof were the same as those of the attracting surface of the adaptor 10.

The first plug 20A of the optical fiber connector 1 in Comparative Example 1-2 had an outer dimension (vertical width Y1×horizontal width X1×length Z1) of 2.96 mm×2.96 mm×1.5 mm. The attracted surface of the first plug 20A had a square shape like the attracting surface of the adaptor 10 and was smaller than the attracting surface within the range of manufacturing variation. An exposed area of as extremely small as 0.02 mm was presented at the outer periphery of the attracting surface. Thus, the first plug 20A in Comparative Example 1-2 had an outer dimension substantially the same as that of the first plug 20A in Comparative Example 1-1. Accordingly, the outer edge of the attracted surface substantially continuously contacted the corresponding outer peripheral edge of the attracting surface.

The first plug 20A of the optical fiber connector 1 in Comparative Example 1-3 had an outer dimension (vertical width Y1×horizontal width X1×length Z1) of 3.04 mm×3.04 mm×1.5 mm. The attracted surface of the first plug 20A had a square shape like the attracting surface of the adaptor 10 and was larger than the attracting surface within the range of manufacturing variation. An exposed area of as extremely small as 0.02 mm was presented at the outer periphery of the attracted surface. Thus, the first plug 20A in Comparative Example 1-3 had an outer dimension substantially the same as that of the first plug 20A in Comparative Example 1-1. Accordingly, the outer edge of the attracted surface substantially continuously contacted the corresponding outer peripheral edge of the attracting surface.

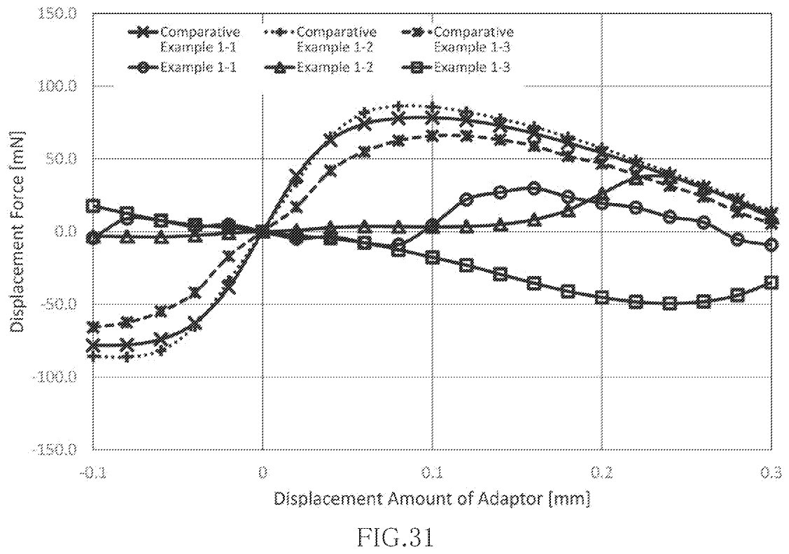

In the evaluation of the displacement force, the adaptor 10 was displaced in the horizontal width direction (X-direction in FIGS. 30A to 30D) with a position at which the center of the insertion hole 12 of the adaptor 10 and the center of the through hole 22 of the first plug 20A coincided with each other set as a reference point (displacement amount of the adaptor position: 0 mm). In this state, a force in the X-direction acting on the adaptor 10 was calculated by simulation. The results are illustrated in FIG. 31. In the graph of FIG. 31, the horizontal axis represents displacement amount [mm] in the X-direction, and the vertical axis represents displacement force [mN] in the X-direction acting on the adaptor 10.

It was found from FIG. 31 that, in Examples 1-1, 1-2, and 1-3, even when the adaptor 10 was slightly displaced in the X-direction from the reference point, a force in the positive X-direction did not act, or a force in the negative X-direction, i.e., a force causing the adaptor 10 to return to the reference point acted.

On the other hand, in Comparative Examples 1-1, 1-2, and 1-3, when the adaptor 10 was slightly displaced in the X-direction from the reference point, a force in the positive X-direction, i.e., a force causing the adaptor 10 to be away from the reference point acted.

### Examples 2-1, 2-2 and Comparative Example 2: Cases Where Connection Surface is Circular

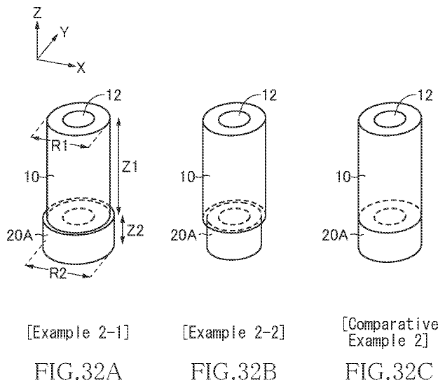

The displacement force of the optical fiber connector 1 having a circular connection surface was evaluated. As illustrated in FIGS. 32A to 32C, the outer dimension (diameter R1×length Z1) of the adaptor 10 of the optical fiber connector 1 was ϕ3 mm×5 mm, and the shape of the attracting surface was circular. The diameter of the insertion hole 12 for the optical fiber was ϕ1.5 mm.

As illustrated in FIG. 32A, the first plug 20A of the optical fiber connector 1 in Example 2-1 had an outer dimension (diameter R2×length Z2) of ϕ3.4 mm×1.5 mm. The attracted surface of the first plug 20A had a circular shape and was slightly larger in area than the attracting surface of the adaptor 10, so that an exposed area having a width of 0.2 mm was presented at the outer periphery of the attracted surface.

As illustrated in FIG. 32B, the first plug 20A of the optical fiber connector 1 in Example 2-2 had an outer dimension (diameter R2×length Z2) of ϕ2.6 mm×1.5 mm. The attracted surface of the first plug 20A had a circular shape and was slightly smaller in area than the attracting surface of the adaptor 10, so that an exposed area having a width of 0.2 mm was presented at the outer periphery of the attracting surface.

On the other hand, as illustrated in FIG. 32C, the first plug 20A of the optical fiber connector 1 in Comparative Example 2 had an outer dimension (diameter R2×length Z2) of ϕ3 mm×1.5 mm, and the shape and size of the attracted surface thereof were the same as those of the attracting surface of the adaptor 10.

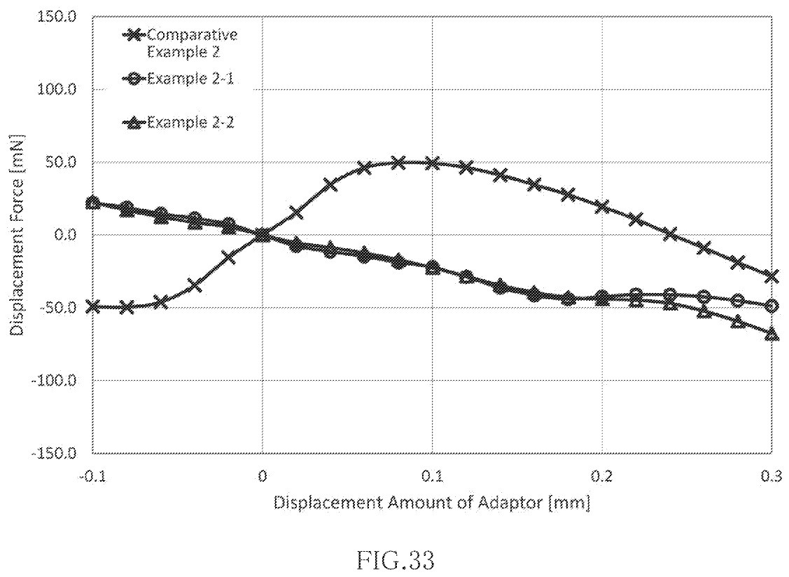

In the evaluation of the displacement force, the adaptor 10 was displaced in the radial direction (X-direction in FIGS. 33A, 33B, and 33C) with a position at which the center of the insertion hole 12 of the adaptor 10 and the center of the through hole 22 of the first plug 20A coincided with each other set as a reference point (displacement amount of the adaptor position: 0 mm). In this state, a force in the X-direction acting on the adaptor 10 was calculated by simulation. The results are illustrated in FIG. 33.

It was found from FIG. 33 that, in Examples 2-1 and 2-2, when the adaptor 10 was slightly displaced in the X-direction from the reference point, a force in the negative X-direction, i.e., a force causing the adaptor 10 to return to the reference point acted.

On the other hand, in Comparative Example 2, when the adaptor 10 was slightly displaced in the X-direction from the reference point, a force in the positive X-direction, i.e., a force causing the adaptor 10 to be away from the reference point acted.

### Examples 3-1, 3-2, 3-3 and Comparative Example 3: Cases Where Connection Surface is Rectangular

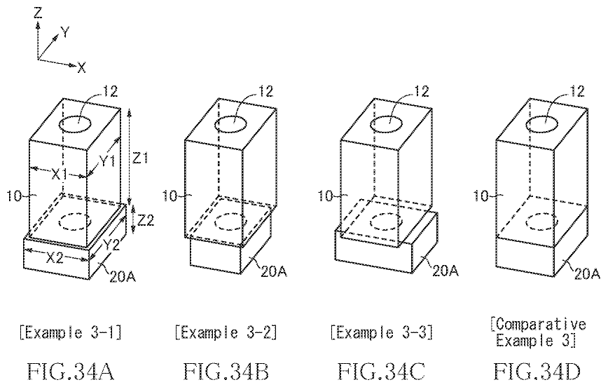

The displacement force of the optical fiber connector 1 having a rectangular connection surface was evaluated. As illustrated in FIGS. 34A to 34D, the outer dimension (vertical width Y1×horizontal width X1×length Z1) of the adaptor 10 of the optical fiber connector 1 in Examples 3-1, 3-2, 3-3 and Comparative Example 3 was 4 mm×3 mm×5 mm. The shape of the attracting surface was rectangular. The diameter of the insertion hole 12 for the optical fiber was ϕ1.5 mm.

As illustrated in FIG. 34A, the first plug 20A of the optical fiber connector 1 in Example 3-1 had an outer dimension (vertical width Y2×horizontal width X2×length Z2) of 4.4 mm×3.4 mm×1.5 mm. The attracted surface of the first plug 20A had a rectangular shape and was slightly larger in area than the attracting surface of the adaptor 10, so that an exposed area having a width of 0.2 mm was presented at the outer periphery of the attracted surface.

As illustrated in FIG. 34B, the first plug 20A of the optical fiber connector 1 in Example 3-2 had an outer dimension (vertical width Y2×horizontal width X2×length Z2) of 4.4 mm×3.4 mm×1.5 mm, and the attracted surface thereof had an area slightly smaller than the attracting surface of the adaptor 10, so that an exposed area having a width of 0.2 mm was presented at the outer periphery of the attracting surface.

Further, as illustrated in FIG. 34C, the first plug 20A of the optical fiber connector 1 in Example 3-3 had an outer dimension (vertical width Y2×horizontal width X2×length Z2) of 3 mm×4 mm×1.5 mm, and the shape and size of the attracted surface thereof were the same as those of the attracting surface of the adaptor 10; however, the first plug 20A and adaptor 10 were disposed such that the longitudinal direction thereof cross each other.

On the other hand, as illustrated in FIG. 34D, the first plug 20A of the optical fiber connector 1 in Comparative Example 3 had an outer dimension (vertical width Y2×horizontal width X2×length Z2) of 3.6 mm×2.6 mm×1.5 mm, and the shape and size of the attracted surface thereof were the same as those of the attracting surface of the adaptor 10.

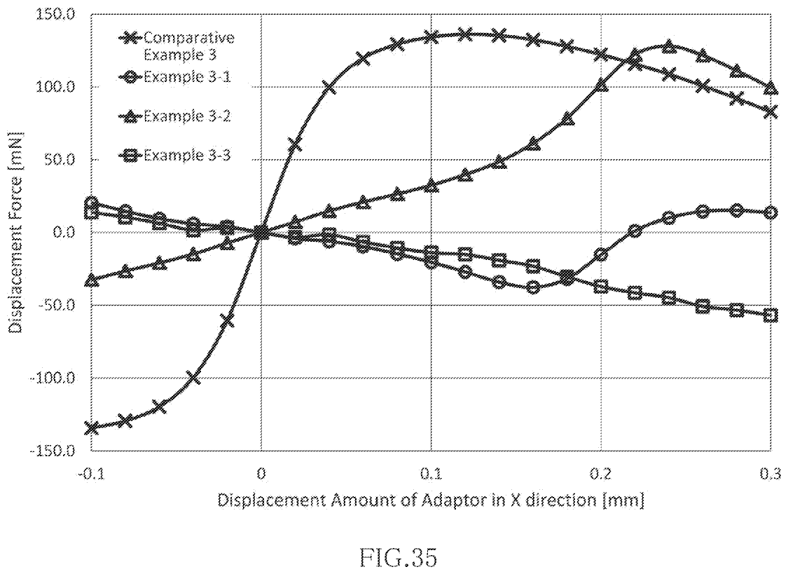

In the evaluation of the displacement force, the adaptor 10 was displaced in the short side direction (X-direction in FIGS. 34A to 34D) of the rectangle with a position at which the center of the insertion hole 12 of the adaptor 10 and the center of the through hole 22 of the first plug 20A coincided with each other set as a reference point (displacement amount of the adaptor position: 0 mm). In this state, a force in the X-direction acting on the adaptor 10 was calculated by simulation. The results are illustrated in FIG. 35.

It was found from FIG. 35 that, in Examples 3-1, 3-2, and 3-3, when the adaptor 10 was slightly displaced in the X-direction from the reference point, a force in the negative X-direction, i.e., a force causing the adaptor 10 to return to the reference point acted.

On the other hand, in Comparative Example 3, when the adaptor 10 was slightly displaced in the X-direction from the reference point, a force in the positive X-direction, i.e., a force causing the adaptor 10 to be away from the reference point acted.

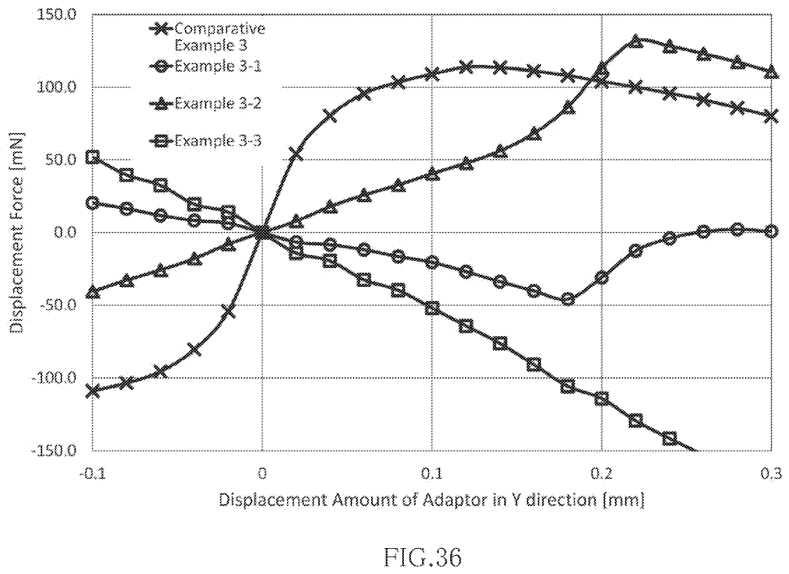

Then, a force in the Y-direction acting on the adaptor 10 when the adaptor 10 was displaced in the long side direction (Y-direction in FIGS. 34A to 34D) of the rectangle was calculated by simulation. The results are illustrated in FIG. 36.

It was found from FIG. 36 that, in Examples 3-1, 3-2, and 3-3, when the adaptor 10 was slightly displaced in the Y-direction from the reference point, a force in the negative Y-direction, i.e., a force causing the adaptor 10 to return to the reference point acted.

On the other hand, in Comparative Example 3, when the adaptor 10 was slightly displaced in the Y-direction from the reference point, a force in the positive Y-direction, i.e., a force causing the adaptor 10 to be away from the reference point acted.

### Examples 4-1, 4-2 and Comparative Example 4: Cases Where Connection Surface is Elliptic

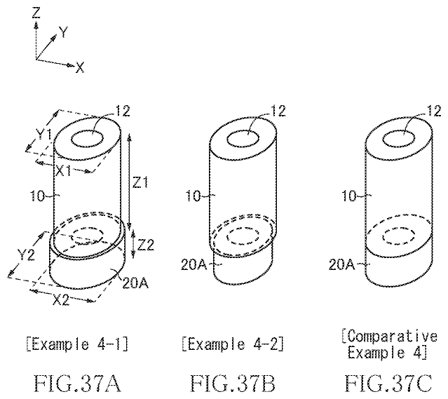

The displacement force of the optical fiber connector 1 having an elliptic connection surface was evaluated. As illustrated in FIGS. 37A to 37C, the outer dimension (major axis Y1×minor axis X1×length Z1) of the adaptor 10 of the optical fiber connector 1 in Examples 4-1, 4-2 and Comparative Example 4 was 4 mm×3 mm×5 mm, and the shape of the attracting surface was elliptic. The diameter of the insertion hole 12 for the optical fiber was ϕ1.5 mm.

As illustrated in FIG. 37A, the first plug 20A of the optical fiber connector 1 in Example 4-1 had an outer dimension (major axis Y2×minor axis X2×length Z2) of 4.4 mm×3.4 mm×1.5 mm. The attracted surface of the first plug 20A had an elliptic shape and was slightly larger in area than the attracting surface of the adaptor 10, so that an exposed area having a width of 0.2 mm was presented at the outer periphery of the attracted surface.

As illustrated in FIG. 37B, the first plug 20A of the optical fiber connector 1 in Example 4-2 had an outer dimension (major axis Y2×minor axis X2×length Z2) of 3.6 mm×2.6 mm×1.5 mm. The attracted surface of the first plug 20A had an elliptic shape and was slightly smaller in area than the attracting surface of the adaptor 10, so that an exposed area having a width of 0.2 mm was presented at the outer periphery of the attracting surface.

On the other hand, as illustrated in FIG. 37C, the first plug 20A of the optical fiber connector 1 in Comparative Example 4 had an outer dimension (major axis Y2×minor axis X2×length Z2) of 4 mm×3 mm×1.5 mm, and the shape and size of the attracted surface thereof were the same as those of the attracting surface of the adaptor 10.

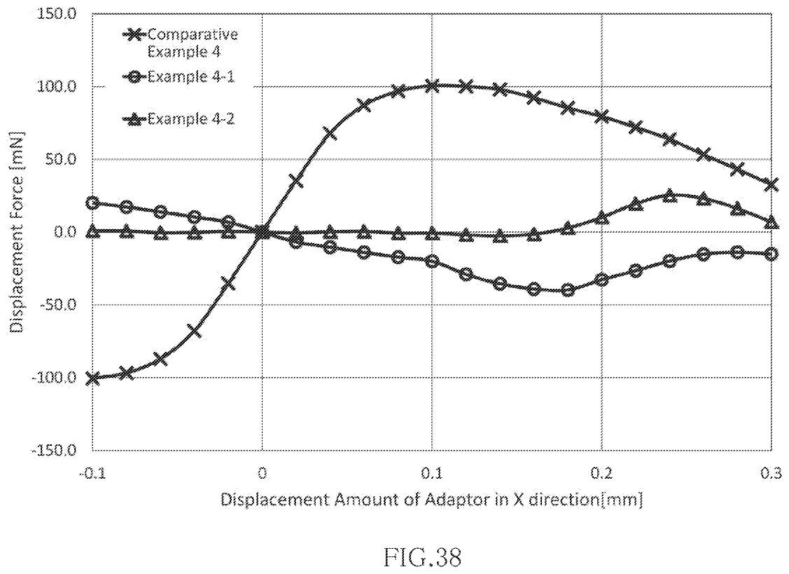

In the evaluation of the displacement force, the adaptor 10 was displaced in the minor axis direction (X-direction in FIGS. 37A to 37C) with a position at which the center of the insertion hole 12 of the adaptor 10 and the center of the through hole 22 of the first plug 20A coincided with each other set as a reference point (displacement amount of the adaptor position: 0 mm). In this state, a force in the X-direction acting on the adaptor 10 was calculated by simulation. The results are illustrated in FIG. 38.

It was found from FIG. 38 that, in Examples 4-1 and 4-2, when the adaptor 10 was slightly displaced in the X-direction from the reference point, a force in the negative X-direction, i.e., a force causing the adaptor 10 to return to the reference point acted.

On the other hand, in Comparative Example 4, when the adaptor 10 was slightly displaced in the X-direction from the reference point, a force in the positive X-direction, i.e., a force causing the adaptor 10 to be away from the reference point acted.

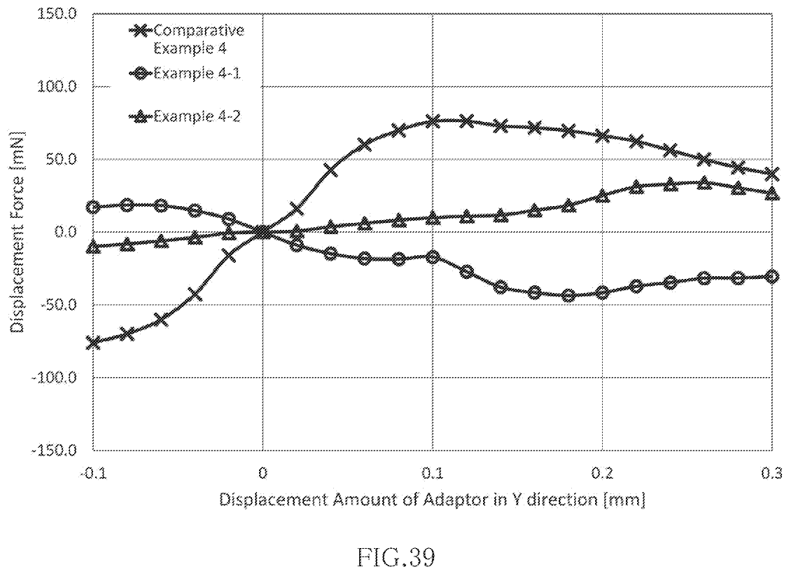

Then, a force in the Y-direction acting on the adaptor 10 when the adaptor 10 was displaced in the major axis direction (Y-direction in FIGS. 37A to 37C) of the ellipse was calculated by simulation. The results are illustrated in FIG. 39.

It was found from FIG. 39 that, in Examples 4-1 and 4-2, when the adaptor 10 was slightly displaced in the Y-direction from the reference point, a force in the negative Y-direction, i.e., a force causing the adaptor 10 to return to the reference point acted.

On the other hand, in Comparative Example 4, when the adaptor 10 was slightly displaced in the Y-direction (minor axis direction) from the reference point, a force in the positive X-direction, i.e., a force causing the adaptor 10 to be away from the reference point acted.

### Examples 5-1 and 5-2 and Comparative Example 5: Cases Where Connection Surface is Square

The displacement force of the optical fiber connector 1 having a square connection surface was evaluated. Although not illustrated, the outer dimension (vertical width Y1×horizontal width X1×length Z1) of the adaptor 10 of the optical fiber connector 1 was common in Examples 5-1 and 5-2 and Comparative Example 5 and was 3.0 mm×3.0 mm×5.0 mm. The diameter of the insertion hole 12 for the optical fiber was ϕ1.0 mm.

Although not illustrated, the first plug 20A of the optical fiber connector 1 in Example 5-1 had an outer dimension (vertical width Y2×horizontal width X2×length Z2) of 6.0 mm×6.0 mm×1.5 mm. The attracted surface of the first plug 20A had a square shape like the attracting surface of the adaptor 10 and was slightly larger in area than the attracting surface, so that an exposed area having a width of 1.5 mm was presented at the outer periphery of the attracted surface.

Although not illustrated, the first plug 20A of the optical fiber connector 1 in Example 5-2 had an outer dimension of 1.5 mm×1.5 mm×1.5 mm. The attracted surface of the first plug 20A had an area slightly smaller than the attracting surface of the adaptor 10, so that an exposed area having a width of 0.75 mm was presented at the outer periphery of the attracted surface.

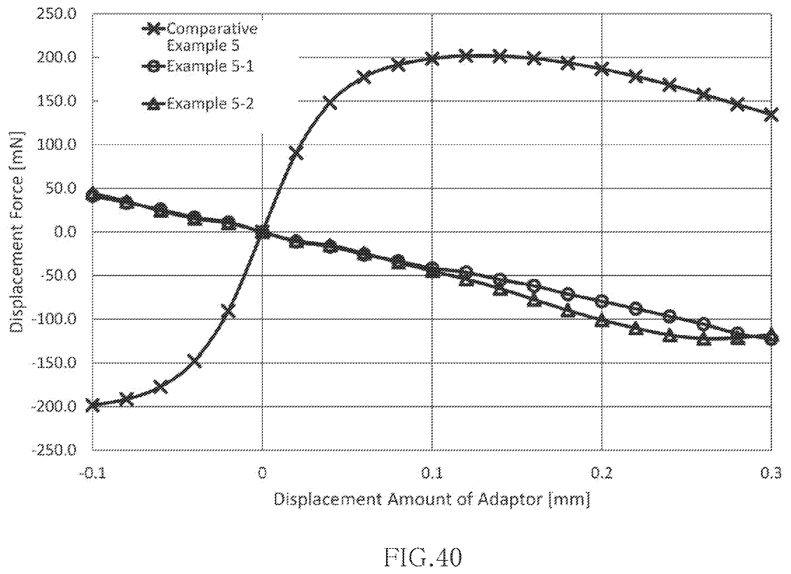

In the evaluation of the displacement force, the adaptor 10 was displaced in the horizontal width direction with a position at which the center of the insertion hole 12 of the adaptor 10 and the center of the through hole 22 of the first plug 20A coincided with each other set as a reference point (displacement amount of the adaptor position: 0 mm). In this state, a force in the X-direction acting on the adaptor 10 was calculated by simulation. The results are illustrated in FIG. 40. In the graph of FIG. 40, the horizontal axis represents displacement amount [mm] in the X-direction, and the vertical axis represents displacement force [mN] in the X-direction acting on the adaptor 10.

As seem from FIG. 40 that, in Example 40, when the adaptor 10 was slightly displaced in the X-direction from the reference point, a force in the negative X-direction, i.e., a force causing the adaptor 10 to return to the reference point acted.

On the other hand, in Comparative Example 5, when the adaptor 10 was slightly displaced in the X-direction from the reference point, a force in the positive X-direction, i.e., a force causing the adaptor 10 to be away from the reference point acted.

The attracting surface and attracted surface in Comparative Example 5 had the same area of 8.21 mm². The attracted surface in Example 5-1 had an area of 35.21 mm², and the attracted surface in Example 5-2 had an area of 1.46 mm². Thus, it was found that when the area ratio of the attracted surface to the attracting surface was 0.18 or more and 4.29 or less, a slight displacement of the adaptor 10 in the X-direction from the reference point caused it to exert a force in the negative X-direction i.e., a force causing the adaptor 10 to return to the reference point.

Further, the difference in position between the outer peripheral edge of the attracted surface in Example 5-1 and the corresponding outer peripheral edge of the attracting surface was 1.5 mm. Thus, it was found that when the difference in position between the outer peripheral edge of the attracted surface and the corresponding outer peripheral edge of the attracting surface was 1.5 mm or less, a slight displacement of the adaptor 10 in the X-direction from the reference point caused it to exert a force in the negative X-direction i.e., a force causing the adaptor 10 to return to the reference point.

Taking the evaluation results of Examples 1-1, 1-2, and 1-3 into consideration, a change in the displacement force with respect to further change in a length W (=Y2=X2) of one side of a square attracted surface of the first plug 20A was calculated by simulation.

The first plug 20A constituted by a magnetic body having a thickness of 1.5 mm and having a square attracted surface in which the length of one side was a variable value W [mm] was attracted to the adaptor 10 constituted by a neodymium sintered magnet having a thickness of 5 mm and having a square attracting surface in which the length of one side was 3.0 mm. As the magnetic body, SUS430 was used. Then, a displacement force generated when the center position of the neodymium sintered magnet was displaced from the center of the magnetic body was calculated by a two-dimensional finite element method. A magnet position refers to a displacement amount of the center position of the neodymium sintered magnet from the center of the magnetic body, and “magnet position=0 mm” refers to a state where the centers of the neodymium sintered magnet and magnetic body coincide with each other. Further, the displacement force having a positive value means that a force acts in a direction increasing the displacement.

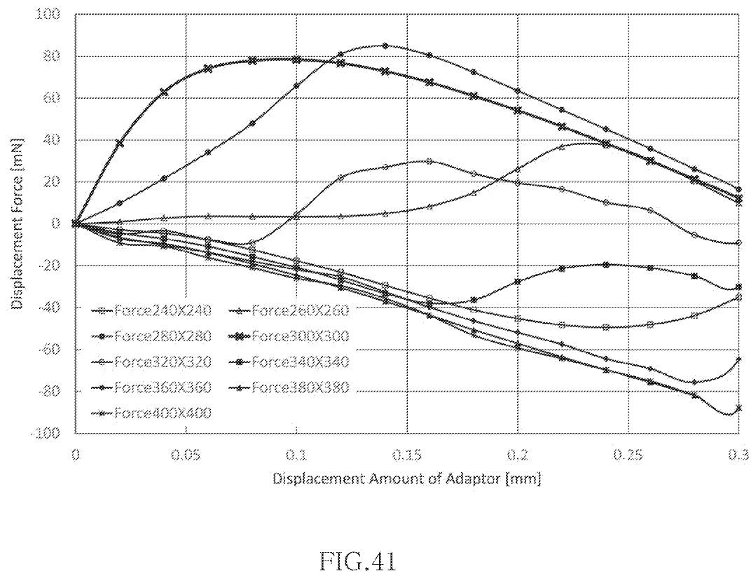

FIG. 41 is a graph illustrating the relation between a displacement amount [mm] of the adaptor position and a displacement force [mN] generated upon the displacement.

As illustrated in FIG. 41, when the length W of one side of the attracted surface was 3.0 mm, that is, when the outer peripheral edge of the magnetic body coincided with the outer peripheral edge of the neodymium sintered magnet, the displacement force assumed a positive value of about 40 mN even with a slight displacement amount of 0.02 mm, indicating that positions of the neodymium sintered magnet and magnetic body were likely to be displaced from each other.

On the other hand, when the length W of one side of the attracted surface was 2.8 mm or less, the displacement force was able to be reduced to 5 mN or less with respect to a displacement amount of 0.02 mm, which was 1/2 or less of the displacement force generated when W=3.0 mm.

Further, when the length W of one side of the attracted surface was 3.2 mm or more, the displacement force assumed a negative value with respect to a displacement amount of 0.02 mm, indicating that a force acted in a direction correcting the displacement. Thus, an effect of reducing the displacement was obtained.

As described above, when the length W of one side of the first plug 20A was 3.0 mm, that is, the size of the attracted surface coincided with that of the attracting surface, a force causing the adaptor 10 to be away from the reference point when the adaptor 10 was slightly displaced from the reference point became maximum. Further, when a size difference between the attracting surface of the permanent magnet and the attracted surface of the magnetic body was the same, a force causing the adaptor 10 to return to the reference point was stronger when the attracted surface of the magnetic body was larger in size than the attracting surface of the permanent magnet than when the attracted surface of the magnetic body was smaller in size than the attracting surface of the permanent magnet.

### REFERENCE SIGNS LIST

1: Optical fiber
10: Adaptor
11: Base body
11a: One end surface of adaptor (first attracting surface)
11b: Other-end surface of adaptor (second attracting
surface)
12: Insertion hole
12a: One insertion port of insertion hole
12b: Other insertion port of insertion hole
14: Split sleeve
20A: First plug
20B: Second plug
21: Plug front-end surface (first or second attracted
surface)
22: Through hole
24A, 24B: Ferrule
26: Cover
27: Support member
28: Guide pin
29: Guide pin insertion hole
30A: First optical fiber
30B: Second optical fiber
31: Optical fiber leading end portion
40A: Gap (first gap)
40B: Gap (second gap)
50: Chamfered portion
60: Spacer
70: Fixing member
110: Permanent magnet
111: Attracting surface
120: Magnetic body
121: Attracted surface
130: Adaptor center portion
140: Non-magnetic body

1. An optical fiber connector comprising:
an adaptor having an insertion hole;
a first plug holding a first optical fiber; and
a second plug holding a second optical fiber, wherein
the adaptor has first and second attracting surfaces having, respectively, one and the other insertion ports of the insertion hole,
the first plug has a first attracted surface that receives, from the first attracting surface, an attractive force generated by a magnetic force when the first optical fiber is inserted into the one insertion port,
one of the first attracting surface and the first attracted surface is constituted by a permanent magnet, and the other one thereof is constituted by a magnetic body,
in a state where leading ends of the respective first and second optical fibers are connected to each other in the insertion hole, at least an outer peripheral edge of the first attracted surface does not continuously contact the corresponding outer peripheral edge of the first attracting surface.

2. The optical fiber connector as claimed in claim 1, wherein
a force in a direction increasing axial misalignment that one of the adaptor and the first plug receives from the other one thereof when a center axis of the first plug is displaced from a center axis of the adaptor is 22 mN or less.

3. The optical fiber connector as claimed in claim 1, wherein
in a state where the leading ends of the respective first and second optical fibers are connected to each other, the entire surface of the first attracted surface is not in contact with the first attracting surface.

4. The optical fiber connector as claimed in claim 3, wherein
the first attracted surface has the same shape and size as those of the first attracting surface, and a first gap between the first attracting surface and the first attracted surface is 0.5 μm or more.

5. The optical fiber connector as claimed in claim 4, wherein an area S of the first attracting surface and the first gap G satisfy a relation of 0.08≤G/S≤38 [1/m].

6. The optical fiber connector as claimed in claim 3, wherein
the outer peripheral edge of at least one of the first attracting surface and the first attracted surface is chamfered.

7. The optical fiber connector as claimed in claim 3, wherein
a non-magnetic body is provided between the first attracting surface and the first attracted surface.

8. The optical fiber connector as claimed in claim 1, wherein
the position of the outer peripheral edge of the first attracted surface in the in-plane direction is displaced from the corresponding outer peripheral edge of the first attracting surface.

9. The optical fiber connector as claimed in claim 1,
wherein
in a state where the leading ends of the respective first and second optical fibers are connected to each other, the first attracted surface has an area contacting the first attracting surface, and
the outer peripheral edge of at least one of the first attracting surface and the first attracted surface is chamfered.

10. The optical fiber connector as claimed in claim 9, wherein
the outer peripheral edges of both the first attracting surface and the first attracted surface are chamfered.

11. The optical fiber connector as claimed in claim 9, wherein
the chamfering width of the outer peripheral edge is 50 μm or more and 400 μm or less.

12. The optical fiber connector as claimed in claim 1, wherein
in a state where the leading ends of the respective first and second optical fibers are connected to each other, the first attracted surface has an area contacting the first attracting surface, and
the position of the outer peripheral edge of the first attracted surface in the in-plane direction is displaced from the corresponding outer peripheral edge of the first attracting surface.

13. The optical fiber connector as claimed in claim 12, wherein
the first attracted surface has the same outer peripheral shape as the first attracting surface.

14. The optical fiber connector as claimed in claim 13, wherein
the first attracted surface has an outer peripheral shape similar to that of the first attracting surface.

15. The optical fiber connector as claimed in claim 12, wherein
the difference in position between the outer peripheral edge of the first attracted surface and the corresponding outer peripheral edge of the first attracting surface is 0.1 mm or more and 1.5 mm or less.

16. The optical fiber connector as claimed in claim 12, wherein
the area ratio of the first attracted surface to the first attracting surface is 0.18 or more and 4.29 or less.

17. The optical fiber connector as claimed in claim 12, wherein
the outer peripheral edge of the first attracted surface is positioned outside the corresponding outer peripheral edge of the first attracting surface.

18. The optical fiber connector as claimed in claim 12, wherein
the outer peripheral edge of at least one of the first attracting surface and the first attracted surface is chamfered.

19. The optical fiber connector as claimed in claim 1, wherein
the first attracting surface is constituted by a permanent magnet, and the first attracted surface is constituted by a magnetic body.

20. The optical fiber connector as claimed in claim 1, wherein
the second plug has a second attracted surface that receives, from the second attracting surface, an attractive force generated by a magnetic force when the second optical fiber is inserted into the other insertion port,
one of the second attracting surface and the second attracted surface is constituted by a permanent magnet, and the other one thereof is constituted by a magnetic body,
in a state where the leading ends of the respective first and second optical fibers are connected to each other in the insertion hole, at least an outer peripheral edge of the second attracted surface does not continuously contact the corresponding outer peripheral edge of the second attracting surface.

21. The optical fiber connector as claimed in claim 20, wherein
a force in a direction increasing axial misalignment that one of the adaptor and the second plug receives from the other one thereof when a center axis of the second plug is displaced from the center axis of the adaptor is 22 mN or less.

22. The optical fiber connector as claimed in claim 20, wherein
in a state where the leading ends of the respective first and second optical fibers are connected to each other, the entire surface of the second attracted surface is not in contact with the second attracting surface.

23. The optical fiber connector as claimed in claim 22, wherein
the second attracted surface has the same shape and size as the second attracting surface, and a second gap between the second attracting surface and the second attracted surface is 0.5 μm or more.

24. The optical fiber connector as claimed in claim 23, wherein
an area S of the second attracting surface and the second gap G satisfy a relation of 0.08≤G/S≤38 [1/m].

25. The optical fiber connector as claimed in claim 22, wherein
the outer peripheral edge of at least one of the second attracting surface and the second attracted surface is chamfered.

26. The optical fiber connector as claimed in claim 22, wherein
a non-magnetic body is provided between the second attracting surface and the second attracted surface.

27. The optical fiber connector as claimed in claim 22, wherein
the position of the outer peripheral edge of the second attracted surface in the in-plane direction is displaced from the corresponding outer peripheral edge of the second attracting surface.

28. The optical fiber connector as claimed in claim 20, wherein
in a state where the leading ends of the respective first and second optical fibers are connected to each other, the second attracted surface has an area contacting the second attracting surface, and
the outer peripheral edge of at least one of the second attracting surface and the second attracted surface is chamfered.

29. The optical fiber connector as claimed in claim 28, wherein
the outer peripheral edges of both the second attracting surface and the second attracted surface are chamfered.

30. The optical fiber connector as claimed in claim 28, wherein
the chamfering width of the outer peripheral edge is 50 μm or more and 400 μm or less.

31. The optical fiber connector as claimed in claim 20, wherein
in a state where the leading ends of the respective first and second optical fibers are connected to each other, the second attracted surface has an area contacting the second attracting surface, and
the position of the outer peripheral edge of the second attracted surface in the in-plane direction is displaced from the corresponding outer peripheral edge of the second attracting surface.

32. The optical fiber connector as claimed in claim 31, wherein
the second attracted surface has the same outer peripheral shape as the second attracting surface.

33. The optical fiber connector as claimed in claim 32, wherein
the second attracted surface has an outer peripheral shape similar to that of the second attracting surface.

34. The optical fiber connector as claimed in claim 31, wherein
the difference in position between the outer peripheral edge of the second attracted surface and the corresponding outer peripheral edge of the second attracting surface is 0.1 mm or more and 1.5 mm or less.

35. The optical fiber connector as claimed in claim 31, wherein
the area ratio of the second attracted surface to the second attracting surface is 0.18 or more and 4.29 or less.

36. The optical fiber connector as claimed in claim 31, wherein
the outer peripheral edge of the second attracted surface is positioned outside the corresponding outer peripheral edge of the second attracting surface.

37. The optical fiber connector as claimed in claim 31, wherein
the outer peripheral edge of at least one of the second attracting surface and the second attracted surface is chamfered.

38. The optical fiber connector as claimed in claim 31, wherein
the second attracting surface is constituted by a permanent magnet, and the second attracted surface is constituted by a magnetic body.

39. The optical fiber connector as claimed in claim 20, wherein
the first attracting surface differs in shape from the second attracting surface, and the first attracted surface differs in shape from the second attracted surface.

40. The optical fiber connector as claimed in claim 1, wherein
the first plug holds a plurality of the first optical fibers,
the second plug holds the second optical fibers as many as the number of the first optical fibers, and
the adaptor has the insertion holes as many as the number of the first optical fibers and connects leading ends of the plurality of first optical fibers and leading ends of the plurality of second optical fibers together.
